(19) United States
(12) Patent Application Publication
(10) Pub. No.: US 2026/0031852 A1
(43) Pub. Date: Jan. 29, 2026

(54) TERMINAL POINT AND BASE STATION OF A TELEGRAM SPLITTING-BASED COMMUNICATION SYSTEM WITH LOW LATENCY IN THE DOWNLINK

(71) Applicant: Fraunhofer-Gesellschaft zur Foerderung der angewandten Forschung e.V., Munich (DE)

(72) Inventors: Gerd KILIAN, Erlangen (DE); Josef BERNHARD, Erlangen (DE); Jakob KNEISSL, Erlangen (DE); Karol BIEG, Erlangen (DE); Dominik SOLLER, Erlangen (DE); Clemens NEUMUELLER, Erlangen (DE); Stefan ERETH, Erlangen (DE); Maximilian BURGER, Erlangen (DE); Raimund MEYER, Fuerth (DE); Frank OBERNOSTERER, Nuernberg (DE); Michael SCHLICHT, Erlangen (DE)

(21) Appl. No.: 19/342,403

(22) Filed: Sep. 26, 2025

Related U.S. Application Data
(63) Continuation of application No. PCT/EP2024/058568, filed on Mar. 28, 2024.

(30) Foreign Application Priority Data
Mar. 29, 2023 (DE) 10 2023 202 892.1

(51) Int. Cl. H04B 1/713; H04B 1/69; H04W 48/08

(52) U.S. Cl. CPC H04B 1/713; H04W 48/08; H04B 2001/6908

(57) ABSTRACT

Embodiments provide a terminal point of the wireless communication system, wherein the terminal point is configured to operate in a first mode and in a second mode, wherein the terminal point is configured to receive a signal, wherein the signal comprises information on a first channel access pattern for the first mode, wherein the terminal point is configured to determine the first channel access pattern for the first mode based on the information on the first channel access pattern, wherein the terminal point is configured to determine a second channel access pattern for the second mode based on the information on the first channel access pattern, wherein the terminal point is configured to transmit and/or receive data in the second mode by using the second channel access pattern, wherein the first channel access pattern for the first mode allows data transmission with a first latency, wherein the second channel access pattern for the second mode allows data transmission with a second latency, wherein the second latency is lower than the first latency.

### CROSS-REFERENCE TO RELATED APPLICATIONS

This application is a continuation of copending International Application No. PCT/EP2024/058568, filed Mar. 28, 2024 which is incorporated herein by reference in its entirety, and additionally claims priority from German Application No. 10 2023 202 892.1, filed Mar. 29, 2023, which is also incorporated herein by reference in its entirety.

Embodiments of the present invention relate to a wireless communication system and, in particular, to a wireless communication system allowing transmission of data from a base station to one or several terminal points (downlink) using a time and/or frequency hopping pattern with low latency.

### BACKGROUND OF THE INVENTION

[1] describes an ultra-narrow band system based on the telegram splitting method [2], which allows, in the uplink at 10 bit payload data in the standard mode, a latency of 3.6 seconds and when using a low-delay hopping pattern, a latency of less than one (1) second.

In the downlink, according to [1], it is only possible to transmit a message after an uplink message has been received. This is a great advantage for battery-operated nodes, as the same have to switch on the receiver only once at a fixed instant after an uplink message. Thereby, the current consumption in the node can be strongly reduced at the expense of the latency and a battery lifespan of more than ten years can be realized.

Typically, such a node does not emit an uplink message more than every ten minutes, which automatically also results in a latency in the downlink of ten minutes.

[2] describes additional options for a synchronous downlink that emits beacons in regular intervals that are received by the node. These beacons include information on which nodes have to be ready for reception after the beacon in order to receive downlink transmission. Typical intervals for such beacons are in the range of 30 seconds to 5 minutes. Thereby, the latency can be further reduced compared to [1], to approximately 30 seconds to 5 minutes.

However, this is at the expense of the energy consumption and therefore, the battery lifespan as all nodes have to at least receive and evaluate the beacons.

However, there are applications that need, apart from the latency of under one (1) second in the uplink also a latency of less than one (1) second in the downlink. However, these nodes have normally a fixed current supply or the battery does not have to last for several years.

### SUMMARY

An embodiment may have a terminal point of a wireless communication system, wherein the terminal point is configured to operate in a first mode and in a second mode, wherein the terminal point is configured to receive a signal, wherein the signal comprises information on a first channel access pattern for the first mode, wherein the terminal point is configured to determine the first channel access pattern for the first mode based on the information on the first channel access pattern, wherein the terminal point is configured to determine a second channel access pattern for the second mode based on the information on the first channel access pattern, wherein the terminal point is configured to transmit and/or receive data in the second mode by using the second channel access pattern, wherein the first channel access pattern for the first mode allows data transmission with a first latency, wherein the second channel access pattern for the second mode allows data transmission with a second latency, wherein the second latency is lower than the first latency.

Another embodiment may have a base station of a wireless communication system, wherein the base station is configured to operate in a first mode and in a second mode, wherein the base station is configured to transmit a signal, wherein the signal comprises information on a first channel access pattern for the first mode, wherein the base station is configured to determine the first channel access pattern for the first mode based on the information on the first channel access pattern, wherein the base station is configured to determine a second channel access pattern for the second mode based on the information on the first channel access pattern, wherein the base station is configured to transmit and/or receive data in the second mode by using the second channel access pattern, wherein the first channel access pattern for the first mode allows data transmission with a first latency, wherein the second channel access pattern for the second mode allows data transmission with a second latency, wherein the second latency is lower than the first latency.

According to another embodiment, a method for operating a terminal point of a communication system, wherein the terminal point is configured to operate in a first mode and in a second mode, may have the steps of: receiving a signal, wherein the signal comprises information on a first channel access pattern for the first mode, determining the first channel access pattern for the first mode based on the information on the first channel access pattern, determining the second channel access pattern for the second mode based on the information on the first channel access pattern, transmitting and/or receiving data by using the second channel access pattern, wherein the first channel access pattern for the first mode allows data transmission with a first latency, wherein the second channel access pattern for the second mode allows data transmission with a second latency, wherein the second latency is lower than the first latency.

According to another embodiment, a method for operating a base station of a communication system, wherein the base station is configured to operate in a first mode and in a second mode, may have the steps of: transmitting a signal, wherein the signal comprises information on a first channel access pattern for the first mode, determining the first channel access pattern for the first mode based on the information on the first channel access pattern, determining the second channel access pattern for the second mode based on the information on the first channel access pattern, transmitting and/or receiving data by using the second channel access pattern, wherein the first channel access pattern for the first mode allows data transmission with a first latency, wherein the second channel access pattern for the second mode allows data transmission with a second latency, wherein the second latency is lower than the first latency.

Embodiments provide a terminal point of a wireless communication system, wherein the terminal point is configured to operate in a first mode [e.g., mode with normal latency] and in a second mode [e.g., mode with low latency], [e.g., wherein the second mode allows transmitting and/or receiving data with lower latency than the first mode], wherein the terminal point is configured to receive a signal, wherein the signal comprises information on a first channel access pattern [e.g., channel access pattern with normal latency or normal-latency channel access pattern] for the first mode, wherein the terminal point is configured to determine the first channel access pattern for the first mode based on an information on the first channel access pattern, wherein the terminal point is configured to determine a second channel access pattern [e.g., channel access pattern with low latency or low-latency channel access pattern] for the second mode based on the information on the first channel access pattern, wherein the terminal point is configured to transmit and/or receive data in the second mode by using the second channel access pattern [e.g., to transmit an uplink data transmission and/or to receive a downlink data transmission by using the second channel access pattern], wherein the first channel access pattern for the first mode allows data transmission with a first latency [e.g., data transmission with normal latency or normal-latency data transmission], wherein the second channel access pattern for the second mode allows data transmission with a second latency [e.g., data transmission with low latency or low-latency data transmission], wherein the second latency is lower than the first latency.

In embodiments, the terminal point is configured to determine the second channel access pattern exclusively based on the information on the first channel access pattern.

In embodiments, the terminal point is configured to determine the first channel access pattern from the information of the signal via a first mapping rule, wherein the terminal point is configured to determine the second channel access pattern from the information of the signal via a second mapping rule.

In embodiments, the information on the first channel access pattern describes a state of a numerical sequence generator for generating a numerical sequence, or the information on the first channel access pattern describes a number of a numerical sequence, wherein the numerical sequence determines the first channel access pattern.

In embodiments, the terminal point is configured to transmit and/or receive data in the first mode using the first channel access pattern.

In embodiments, the first channel access pattern indicates a frequency and/or time hopping-based occupancy of resource elements usable for the communication of the communication system.

In embodiments, the second channel access pattern indicates a frequency and/or time hopping-based occupancy of resource elements usable for the communication of the communication system.

In embodiments, the terminal point is configured to transmit and/or receive data in the first mode in a [e.g., proper] subset of the occupancy of resource elements indicated by the first channel access pattern.

In embodiments, the terminal point is configured to transmit and/or receive data in the second mode in a [e.g., proper] subset of the occupancy of resource elements indicated by the second channel access pattern.

In embodiments, time intervals [e.g., breaks] between immediately successive resource elements of the first channel access pattern are greater [e.g., by the factor 2] than time lengths [or durations] of the resource elements of the second channel access pattern.

In embodiments, one resource element of the second channel access pattern each is in time within a respective time interval between two immediately successive resource elements of the first channel access pattern.

In embodiments, a reference point [e.g., reference time; e.g., start, middle or end] of a respective resource element of the second channel access pattern comprises a fixed time interval to a reference point [e.g., reference time; e.g., start, middle, or end] of a respective resource element of the first channel access pattern.

In embodiments, the resource elements of the first channel access pattern are defined temporally relative to a periodic grid [e.g., time grid], wherein a reference point [e.g., reference time; e.g., start, middle or end] of a respective resource element of the second channel access pattern comprises a fixed time interval to a respective grid point of the periodic grid.

In embodiments, the fixed time interval is 136 symbol durations or 57.1 ms.

In embodiments, the fixed time interval is 78.75 symbol durations or 33.1 ms.

In embodiments, a respective resource element of the second channel access pattern is on the same frequency as a respective resource element of the first channel access pattern.

In embodiments, a respective resource element of the second channel access pattern comprises a fixed frequency spacing to a respective resource element of the first channel access pattern.

In embodiments, the terminal point is configured to transmit and/or receive data [e.g., a data packet (e.g., of the physical layer)] divided onto a plurality of sub-data packets according to the second channel access pattern, wherein one or several sub-data packets of the plurality of sub-data packets are transmitted and/or received in one resource element of the second channel access pattern.

In embodiments, a respective sub-data packet of the plurality of sub-data packets comprises a pseudo-random offset in time and/or frequency within a respective resource element of the second channel access pattern.

In embodiments, a data rate of the data transmitted in the second channel access pattern is higher than a data rate of the data transmitted in the first channel access pattern.

In embodiments, the sub-data packets are channel-encoded, such that for successful decoding of the data, in an error-free transmission or a sufficient signal noise ratio, only a proper subset of the plurality of sub-data packets is needed.

In embodiments, the terminal point is configured to receive and decode a proper subset of the plurality of sub-data packets to obtain the data, wherein the terminal point is configured to receive no further sub-data packets of the plurality of sub-data packets if the decoding of the data based on a proper subset of the plurality of data packets has been successful.

In embodiments, several different sub-data packets of the plurality of sub-data packets are transmitted and/or received in a resource element of the second channel access pattern.

In embodiments, at least one proper subset of the plurality of sub-data packets are transmitted repeatedly, wherein at least a first emission of a first sub-data packet and a repeated emission of a second sub-data packet are included in a resource element of the second channel access pattern, wherein the first sub-data packet and the second sub-data packet are different.

In embodiments, the data include one or several sub-data packets, wherein transmission of a data packet can start only in each x-th resource element of the second channel access pattern, wherein x is a natural number greater than 3 [e.g., 4, 5, 6, 10, 12 or 18].

In embodiments, the terminal point is configured to derive the number x from the information on the first channel access pattern.

In embodiments, the terminal point is configured to obtain the number x from a base station of the communication system [e.g., when registering with the base station].

In embodiments, the number x is predetermined [e.g., preconfigured (e.g., the information can be the same across the system and hence known in advance (e.g., at the time of installing the software))].

In embodiments, the data comprise a pilot sequence, wherein the pilot sequence is derived from information [e.g., address of the terminal point] identifying the terminal point [e.g., clearly or ambiguously], wherein the terminal point is configured to receive the data when the terminal point is identified [e.g., addressed] via the pilot sequence.

In embodiments, the terminal point is configured to cancel receiving the data when the terminal point is not identified by the pilot sequence.

In embodiments, the information on the first channel access pattern describes a number of a numerical sequence, wherein the numerical sequence determines the first channel access pattern, wherein the data are encrypted by means of encryption, wherein a counter [e.g., beacon counter] used for the encryption is derived from the first channel access pattern or from the number of the numerical sequence.

In embodiments, the counter is a first counter, wherein further a second counter [e.g., resource element counter] is used for encryption.

In embodiments, the data comprise the second counter.

In embodiments, the terminal point is configured to receive a control signal [e.g., wherein the control signal coordinates access to the resources of the first channel access pattern] [e.g., wherein the control signal is transmitted in fixed [e.g., periodic] resource elements of the first channel access pattern], wherein the terminal point is configured to modify the second counter according to receiving the control signal [e.g., to reset the same].

In embodiments, the control signal is periodically transmitted, wherein the second counter is reset after each transmission of the control signal.

In embodiments, the terminal point is configured to receive data [e.g., a data packet (e.g., of the physical layer)] divided into a plurality of sub-data packets according to the second channel access pattern, wherein the plurality of sub-data packets is transmitted in a plurality of successive resource elements of the second channel access pattern, wherein an order in which the plurality of sub-data packets are transmitted depends on indices of the resource elements of the second channel access pattern, in which the plurality of sub-data packets are transmitted, or wherein an order in which the plurality of sub-data packets are transmitted depends on indices of the resource elements of the first channel access pattern that immediately precede the respective resource elements of the second channel access pattern in which the plurality of sub-data packets are transmitted.

In embodiments, the order in which the plurality of sub-data packets are transmitted, further depends on an index of a slot within the respective resource elements of the plurality of successive resource elements of the second channel access pattern in which the plurality of sub-data packets are transmitted.

In embodiments, the data include a data packet that is transmitted divided into five sub-data packets, wherein the plurality of sub-data packets are transmitted in five successive resource elements of the second channel access pattern, wherein an order in which the five sub-data packets are transmitted depends on
an index of a resource element of the first channel access pattern immediately preceding a respective resource element of the second channel access pattern in which a transmission of the five sub-data packets starts and
an index of a slot within the respective resource elements in which the five sub-data packets are transmitted,
   wherein the order in which the five sub-data packets are transmitted is based on the following table:

| | | Resource element index | | | | | | | |
|---|---|---|---|---|---|---|---|---|---|
| | | 0 | 1 | 2 | 3 | 4 | 5 | 6 | 7 |
| Slot | 0 | 0 | 1 | 2 | 3 | 4 | 0 | 1 | 2 |
| index | 1 | 3 | 4 | 0 | 1 | 2 | 3 | 4 | 0 |
| | 2 | 2 | 3 | 4 | 0 | 1 | 2 | 3 | 4 |
| | 3 | 1 | 2 | 3 | 4 | 0 | 1 | 2 | 3 |

wherein each element in the table describes an index of a respective sub-data packet.

Further embodiments provide a base station of a wireless communication system, wherein the base station is configured to operate in a first mode [e.g., mode with normal latency] and a second mode [e.g., mode with low latency], [e.g., wherein the second mode allows transmitting and/or receiving of data with lower latency than the first mode], wherein the base station is configured to transmit a signal, wherein the signal comprises information on a first channel access pattern [e.g., channel access pattern with normal latency or normal-latency channel access pattern] for the first mode, wherein the base station is configured to determine the first channel access pattern for the first mode based on the information on the first channel access pattern, wherein the base station is configured to determine a second channel access pattern [e.g., channel access pattern with low latency or low-latency channel access pattern] for the second mode based on the information on the first channel access pattern, wherein the base station is configured to transmit and/or receive data in a second mode by using the second channel access pattern [e.g., to receive an uplink data transmission and/or to transmit a downlink data transmission by using the second channel access pattern], wherein the first channel access pattern for the first mode allows data transmission with a first latency [e.g., data transmission with normal latency or normal-latency data transmission], wherein the second channel access pattern for the second mode allows data transmission with a second latency [e.g., data transmission with low latency or low-latency data transmission], wherein the second latency is lower than the first latency.

In embodiments, the base station is configured to determine the second channel access pattern exclusively based on the information on the first channel access pattern.

In embodiments, the base station is configured to determine the first channel access pattern from the information of the signal via a first mapping rule, wherein the base station is configured to determine the second channel access pattern from the information of the signal via a second mapping rule.

In embodiments, the information on the first channel access pattern describes a state of a numerical sequence generator for generating a numerical sequence or the information on the first channel access pattern describes a number of a numerical sequence, wherein the numerical sequence determines the first channel access pattern.

In embodiments, the base station is configured to transmit and/or receive data in the first mode by using the first channel access pattern.

In embodiments, the first channel access pattern indicates a frequency and/or time hopping based occupancy of resource elements usable for the communication of the communication system.

In embodiments, the second channel access pattern indicates a frequency and/or time hopping based occupancy of resource elements usable for the communication of the communication system.

In embodiments, the base station is configured to transmit and/or receive data in the first mode in a [e.g., proper] subset of the occupancy of resource elements indicated by the first channel access pattern.

In embodiments, the base station is configured to transmit and/or receive data in the second mode in a [e.g., proper] subset of the occupancy of resource elements indicated by the second channel access pattern.

In embodiments, time intervals [e.g., breaks] between immediately successive resource elements of the first channel access pattern are greater [e.g., by the factor 2] than time lengths [or durations] of the resource elements of the second channel access pattern.

In embodiments, one resource element of the second channel access pattern each is in time within a respective time interval between two immediately successive resource elements of the first channel access pattern.

In embodiments, a reference point [e.g., reference time; e.g., start, middle or end] of a respective resource element of the second channel access pattern comprises a fixed time interval to a reference point [e.g., reference time; e.g., start, middle, or end] of a respective resource element of the first channel access pattern.

In embodiments, the resource elements of the first channel access pattern are defined temporally relative to a periodic grid [e.g., time grid], wherein a reference point [e.g., reference time; e.g., start, middle or end] of a respective resource element of the second channel access pattern comprises a fixed time interval to a respective grid point of the periodic grid.

In embodiments, the fixed time interval is 136 symbol durations or 57.1 ms.

In embodiments, the fixed time interval is 78.75 symbol durations or 33.1 ms.

In embodiments, a respective resource element of the second channel access pattern is on the same frequency as a respective resource element of the first channel access pattern.

In embodiments, a respective resource element of the second channel access pattern comprises a fixed frequency spacing to a respective resource element of the first channel access pattern.

In embodiments, the base station is configured to transmit and/or receive data [e.g., a data packet (e.g., of the physical layer)] divided onto a plurality of sub-data packets according to the second channel access pattern, wherein one or several sub-data packets of the plurality of sub-data packets are transmitted and/or received in one resource element of the second channel access pattern.

In embodiments, a respective sub-data packet of the plurality of sub-data packets comprises a pseudo-random offset in time and/or frequency within a respective resource element of the second channel access pattern.

In embodiments, a data rate of the data transmitted in the second channel access pattern is higher than a data rate of the data transmitted in the first channel access pattern.

In embodiments, the sub-data packets are channel-encoded, such that for successful decoding of the data, in an error-free transmission or a sufficient signal noise ratio, only a proper subset of the plurality of sub-data packets is needed.

In embodiments, the base station is configured to receive and decode a proper subset of the plurality of sub-data packets to obtain the data, wherein the base station is configured to receive no further sub-data packets of the plurality of sub-data packets if the decoding of the data based on a proper subset of the plurality of data packets has been successful.

In embodiments, several different sub-data packets of the plurality of sub-data packets are transmitted and/or received in a resource element of the second channel access pattern.

In embodiments, at least one proper subset of the plurality of sub-data packets is transmitted repeatedly, wherein at least a first emission of a first sub-data packet and a repeated emission of a second sub-data packet are included in a resource element of the second channel access pattern, wherein the first sub-data packet and the second sub-data packet are different.

In embodiments, the data include one or several sub-data packets, wherein transmission of a data packet can start only in each x-th resource element of the second channel access pattern, wherein x is a natural number greater than 3 [e.g., 4, 5, 6, 10, 12 or 18].

In embodiments, the base station is configured to derive the number x from the information on the first channel access pattern.

In embodiments, the number x is predetermined [e.g., preconfigured (e.g., the information can be the same across the system and hence known in advance (e.g., at the time of installing the software))].

In embodiments, the number x is predetermined by the terminal point [e.g. based on capabilities of the terminal point (e.g. current consumption, computing power)].

In embodiments, the base station is configured to transmit the data to a terminal point, wherein the data comprise a pilot sequence, wherein base station is configured to derive the pilot sequence from information [e.g., address of the terminal point] identifying the terminal point [e.g., clearly or ambiguously].

In embodiments, the information on the first channel access pattern describes a number of a numerical sequence, wherein the numerical sequence determines the first channel access pattern, wherein the base station is configured to encrypt the data by means of encryption, wherein a counter [e.g., beacon counter] used for the encryption is derived from the first channel access pattern or from the number of the numerical sequence.

In embodiments, the counter is a first counter, wherein the base station is configured to further use a second counter [e.g., resource element counter] for encryption.

In embodiments, the base station is configured to provide the data with the second counter.

In embodiments, the base station is configured to transmit a control signal [e.g., wherein the control signal coordinates access to the resources of the first channel access pattern] [e.g., wherein the control signal is transmitted in fixed [e.g., periodic] resource elements of the first channel access pattern], wherein the base station is configured to modify the second counter according to receiving the control signal [e.g., to reset the same].

In embodiments, the control signal is periodically transmitted, wherein the second counter is reset after each transmission of the control signal.

In embodiments, the base station is configured to transmit data [e.g., a data packet (e.g., of the physical layer)] divided into a plurality of sub-data packets according to the second channel access pattern, wherein the plurality of sub-data packets is transmitted in a plurality of successive resource elements of the second channel access pattern, wherein an order in which the plurality of sub-data packets are transmitted depends on indices of the resource elements of the second channel access pattern, in which the plurality of sub-data packets are transmitted, or wherein an order in which the plurality of sub-data packets are transmitted depends on indices of the resource elements of the first channel access pattern that immediately precede the respective resource elements of the second channel access pattern in which the plurality of sub-data packets are transmitted.

In embodiments, the order in which the plurality of sub-data packets are transmitted, further depends on an index of a slot within the respective resource elements of the plurality of successive resource elements of the second channel access pattern in which the plurality of sub-data packets are transmitted.

In embodiments, the data include a data packet that is transmitted divided into five sub-data packets, wherein the plurality of sub-data packets are transmitted in five successive resource elements of the second channel access pattern, wherein an order in which the five sub-data packets are transmitted depends on
an index of a resource element of the first channel access pattern immediately preceding a respective resource element of the second channel access pattern in which a transmission of the five sub-data packets starts and
an index of a slot within the respective resource elements in which the five sub-data packets are transmitted,
   wherein the order in which the five sub-data packets are transmitted is based on the following table:

| | | Resource element index | | | | | | | |
|---|---|---|---|---|---|---|---|---|---|
| | | 0 | 1 | 2 | 3 | 4 | 5 | 6 | 7 |
| Slot | 0 | 0 | 1 | 2 | 3 | 4 | 0 | 1 | 2 |
| index | 1 | 3 | 4 | 0 | 1 | 2 | 3 | 4 | 0 |
| | 2 | 2 | 3 | 4 | 0 | 1 | 2 | 3 | 4 |
| | 3 | 1 | 2 | 3 | 4 | 0 | 1 | 2 | 3 |

wherein each element in the table describes an index of a respective sub-data packet.

Further embodiments provide a method for operating a terminal point of a communication system, wherein the terminal point is configured to operate in a first mode [e.g., mode with normal latency] and a second mode [e.g., mode with low latency], [e.g., wherein the second mode allows transmitting and/or receiving of data with lower latency than the first mode]. The method includes a step of receiving a signal, wherein the signal comprises information on a first channel access pattern [e.g., channel access pattern with normal latency or normal-latency channel access pattern] for the first mode. Further, the method includes a step of determining the first channel access pattern for the first mode based on the information on the first channel access pattern. Further, the method includes a step of determining the second channel access pattern [e.g., channel access pattern with low latency or low-latency channel access pattern] for the second mode based on the information on the first channel access pattern. Further, the method includes a step of transmitting and/or receiving data by using the second channel access pattern, wherein the first channel access pattern for the first mode allows data transmission with a first latency [e.g., data transmission with normal latency or normal-latency data transmission], wherein the second channel access pattern for the second mode allows data transmission with a second latency [e.g., data transmission with low latency or low-latency data transmission], wherein the second latency is lower than the first latency.

Further embodiments provide a method for operating a base station of a communication system, wherein the base station is configured to operate in a first mode [e.g., mode with normal latency] and a second mode [e.g., mode with low latency], [e.g., wherein the second mode allows transmitting and/or receiving of data with lower latency than the first mode]. The method includes a step of transmitting a signal, wherein the signal comprises information on a first channel access pattern [e.g., channel access pattern with normal latency or normal-latency channel access pattern] for the first mode. Further, the method includes a step of determining the first channel access pattern for the first mode based on the information on the first channel access pattern. Further, the method includes a step of determining the second channel access pattern [e.g., channel access pattern with low latency or low-latency channel access pattern] for the second mode based on the information on the first channel access pattern. Further, the method includes a step of transmitting and/or receiving data by using the second channel access pattern, wherein the first channel access pattern for the first mode allows data transmission with a first latency [e.g., data transmission with normal latency or normal-latency data transmission], wherein the second channel access pattern for the second mode allows data transmission with a second latency [e.g., data transmission with low latency or low-latency data transmission], wherein the second latency is lower than the first latency.

Embodiments of the present invention allow a latency of less than one (1) second in the downlink while utilizing the telegram splitting method to allow high interference immunity.

### BRIEF DESCRIPTION OF THE DRAWINGS

Embodiments of the present invention will be detailed subsequently referring to the appended drawings, in which:

FIG. 1 shows a schematic block circuit diagram of a communication arrangement with a first communication system, according to an embodiment of the present invention,

FIG. 2 shows a schematic block circuit diagram of a communication arrangement of two mutually uncoordinated networks having one base station and four associated terminal devices each, according to an embodiment of the present invention,

FIG. 3 shows, in a diagram, a division of the frequency band into resources and a frequency hop-based and time hop-based occupancy of the resources of the frequency band defined by two different channel access patterns, according to an embodiment of the present invention,

FIG. 4 shows a schematic block circuit diagram of a communication system with one base station and a plurality of terminal points, according to an embodiment of the present invention,

FIG. 5 shows a schematic block circuit diagram of a controller for generating a channel access pattern, according to an embodiment of the present invention,

FIG. 6 shows a schematic block circuit diagram of a controller for generating a channel access pattern, according to a further embodiment of the present invention,

FIG. 7 shows a schematic block circuit diagram of a section of the controller, according to an embodiment of the present invention,

FIG. 8 shows a schematic block circuit diagram of a communication system with one base station and two terminal points, according to an embodiment of the present invention,

FIG. 9 in a diagram a schematic view of a sequence of instants defining a temporal position of the resource elements of the channel access pattern, wherein the instants are pseudo-randomly distributed within respective time periods that are each defined by a predetermined minimum time interval and a predetermined maximum time interval to an immediately preceding instant of the sequence of instants according to an embodiment of the present invention,

FIG. 10 in a diagram a schematic view of the resource elements of the first channel access pattern as well as the resource elements of the second channel access pattern, wherein the resource elements of the second channel access pattern are between the resource elements of the first channel access pattern according to an embodiment of the present invention,

FIG. 11 a schematic view of a position of the resource elements of the first channel access pattern and the resource elements of the second channel access pattern according to an embodiment of the present invention,

FIG. 12 a schematic view of a structure of a sub-data packet with (ultra-) low latency according to an embodiment of the present invention,

FIG. 13 in a diagram a schematic view of an occupancy of a communication channel when transmitting five sub-data packets with (ultra-) low latency and

FIG. 14 in a diagram a schematic view of an allocation of the sub-data packets according to their indices based on the selected time slot for the first eight resource elements of the second channel access pattern.

### DETAILED DESCRIPTION OF THE INVENTION

In the following description of the embodiments of the present invention, the same or equal elements are provided with the same reference numbers in the figures, so that the description of the same is inter-exchangeable.

### A. Channel Access Pattern

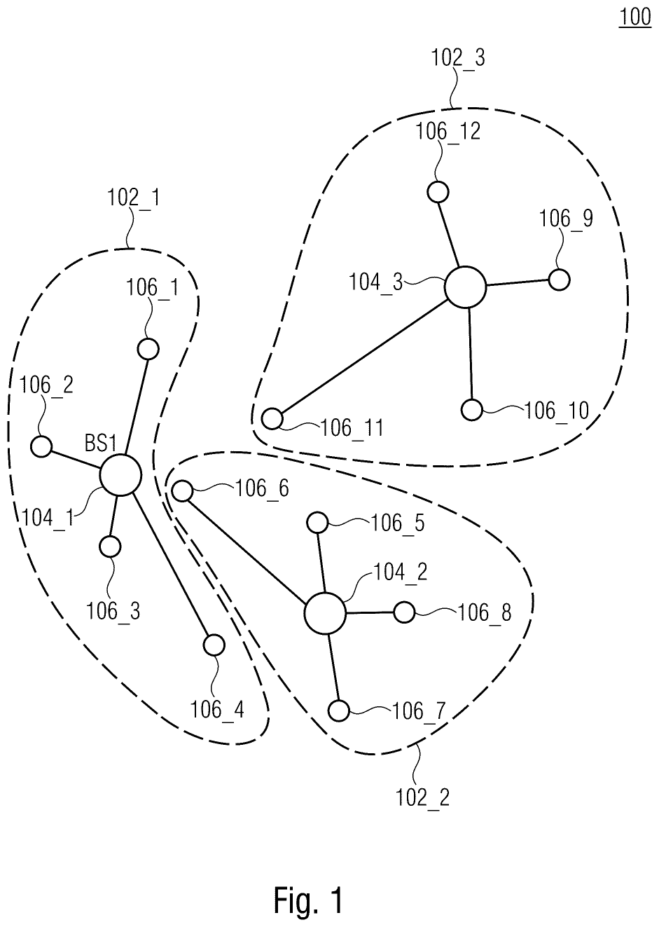

FIG. 1 shows a schematic block circuit diagram of a communication arrangement 100 with a first communication system 102_1, according to an embodiment of the present invention.

The first communication system 102_1 may comprise a base station 104_1 and one or several terminal points 106_1-106_n, wherein n is a natural number larger than or equal to one. In the embodiment shown in FIG. 1, for illustrative purposes, the first communication system 102_1 comprises four terminal points 106_1-106_4, however, the first communication system 102_1 may also comprise 1, 10, 100, 1.000, 10.000, or even 100,000 terminal points.

The first communication system 102_1 may be configured to wirelessly communicate in a frequency band (e.g. a license-free and/or permission-free frequency band such as the ISM bands) used for communication by a plurality of communication systems. In this case, the frequency band may comprise a significantly larger (e.g. at least larger by a factor of two) bandwidth than reception filters of the participants of the first communication system 102_1.

As is indicated in FIG. 1, a second communication system 102_2 and a third communication system 102_3 may be in the range of the first communication system 102_1, for example, wherein these three communication systems 102_1, 102_2, and 102_3 may use the same frequency band to wirelessly communicate.

In embodiments, the first communication system 102_1 may be configured to use for the communication different frequencies or frequency channels of the frequency band (e.g. into which the frequency band is divided) in portions (e.g. in time slots) on the basis of a channel access pattern, regardless of whether these are used by another communication system (e.g. the second communication system 102_2 and/or the third communication system 102_3), wherein the channel access pattern differs from another channel access pattern based on which at least one other communication system of the plurality of other communication systems (e.g. the second communication system 102_2) accesses the frequency band.

In such a communication arrangement 100 shown in FIG. 1, the signals of mutually uncoordinated communication systems (e.g. the first communication system 102_1 and the second communication system 102_2) may therefore be separated from one another by different channel access patterns so that a reciprocal disturbance by interferences is avoided or minimized.

For example, participants of the first communication system 102_1, e.g. a base station 104_1 and several terminal points 106_1-106_4, may wirelessly communicate among themselves on the basis of a channel access pattern (e.g. which indicates a frequency hop-based occupancy (e.g. of resources) of the frequency band, usable for the communication of the first communication system 102_1), whereas participants of the second communication system 102_2, e.g. a base station 104_2 and several terminal points 106_5-106_8, may wirelessly communicate among themselves on the basis of another channel access pattern (e.g. which indicates a frequency hop-based occupancy (e.g. of resources) of the frequency band, usable for the communication of the second communication system 102_2), wherein the channel access pattern and the other channel access pattern are different (e.g. comprise an overlap of less than 20% in the resources used, in the ideal case there is no overlap).

As mentioned above, the communication systems (e.g. the first communication system 102_1 and the second communication system 102_2) are mutually uncoordinated.

The communication systems 102_1, 102_2, 102_3 being mutually uncoordinated refers to the fact that the communication systems mutually (=among the communication systems) do not exchange any information about the respectively used channel access pattern, or, in other words, a communication system does not have any knowledge about the channel access pattern used by another communication system. Thus, the first communication system 102_1 does not know which channel access pattern is used by another communication system (e.g. the second communication system 102_2).

Thus, embodiments refer to a communication arrangement 100 of mutually uncoordinated and, possibly, mutually unsynchronized radio networks (or communication systems) 102_1, 102_2 for the transfer of data which access a mutually used frequency band. In other words, there are at least two radio networks 102_1, 102_2 that operate independently of one another. Both networks 102_1, 102_2 use the same frequency band.

In embodiments, it is assumed that in each individual data transfer only a (small) part of the frequency band is used, e.g. a frequency channel or a partial frequency channel. For example, the frequency band may be split into (partial) frequency channels, wherein a frequency channel is a proper subset of the total frequency band. The totality of all available frequency channels constitutes the frequency band used. For example, in the telegram splitting method, the transfer of a message (data packet) may be carried out consecutively via a sequence of different frequency channels. In this case, embodiments are particularly useful.

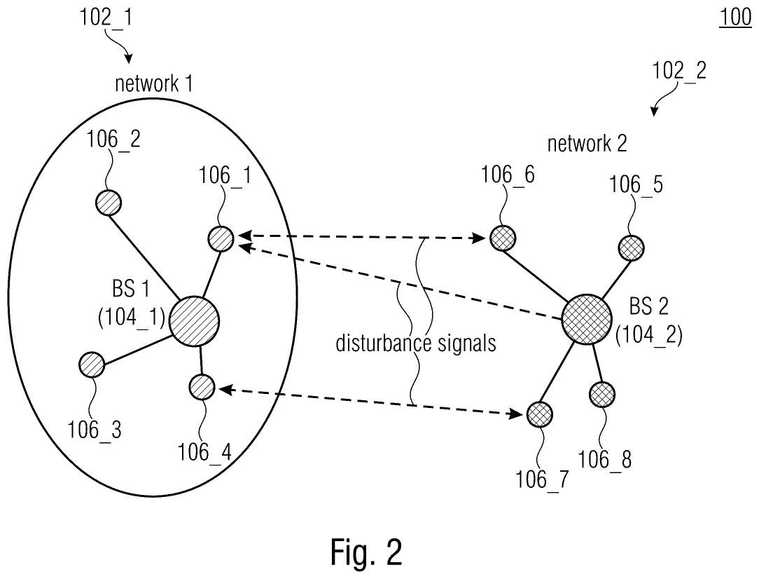

Oftentimes, networks (or communication systems) 102_1, 102_2 are arranged such that transmission signals of participants of a network (e.g. the communication system 102_2) can also be received by participants of other nearby networks (e.g. the communication system 102_1). There, they act as disturbance signals (interferences) that, in principal, may significantly decrease the performance of a radio transfer system, as is shown in FIG. 2.

In detail, FIG. 2 shows a schematic view of two mutually uncoordinated networks 102_1, 102_2 with a base station (BS 1) 104_1, (BS 2) 104_2, respectively, and four associated terminal devices 106_1-106_4, 106_5-106_8, respectively. In other words, FIG. 2 shows an example network topology for two networks 102_1, 102_2 with base stations (BS 1) 104_1, (BS 2) 104_2 and four terminal devices 106_1-106_4, 106_5-106_8 each. The dashed arrows 108 exemplarily symbolize potential disturbance signals, i.e. the radio participants may receive the transmission signals of the receivers from the respectively other network as disturbance signals. Depending on the circumstances, a multitude of networks may be in a mutual reception range so that the participants (base stations or terminal devices) may be possibly exposed to a significant number of disturbers from other networks.

If (as mentioned above) the frequency band as a commonly used resource is divided into individual non-overlapping frequency channels, the effect of the disturbance signals may be significantly reduced. In mutually coordinated networks, a part of the frequency band (a set of frequency channels) may be exclusively allocated to each network so that the reciprocal disturbance (interference) may be minimized. In fully uncoordinated networks, this is not possible.

Thus, in embodiments, accessing the physical transform medium (i.e. the physical radio channel) is implemented in each network such that at least one of the following is fulfilled:
a) the channel access, i.e. the frequency occupancy and time occupancy of the radio channel, in a network has as little overlap as possible in time and frequency with the channel access in another network of the same standard (high degree of “orthogonality”),
b) the channel access has a (pseudo) random character within desired specifications (e.g. mean access frequency per time) (“randomness”),
c) as far as this is avoidable according to the specifications, there are not any longer sequences of an identical (in time and frequency) channel access between networks (“avoidance of systematic overlaps”),
d) all frequency channels within the frequency band are used as regularly as possible in order to achieve as high a frequency diversity as possible and, possibly, the adherence to official regulatory specifications (“uniform distribution of the frequency channel used”),
e) the information about the frequency occupancy and time occupancy of the radio channels, e.g. for new participants joining a network, may be transmitted with as little signaling effort as possible (“reduction of signaling information”).

Simply put, in embodiments, a mutual disturbance between several networks (intern-network interference) is reduced by carrying out the channel access to the mutually used frequency band differently in frequency and time, advantageously as “orthogonal” as possible and with a (pseudo) random character.

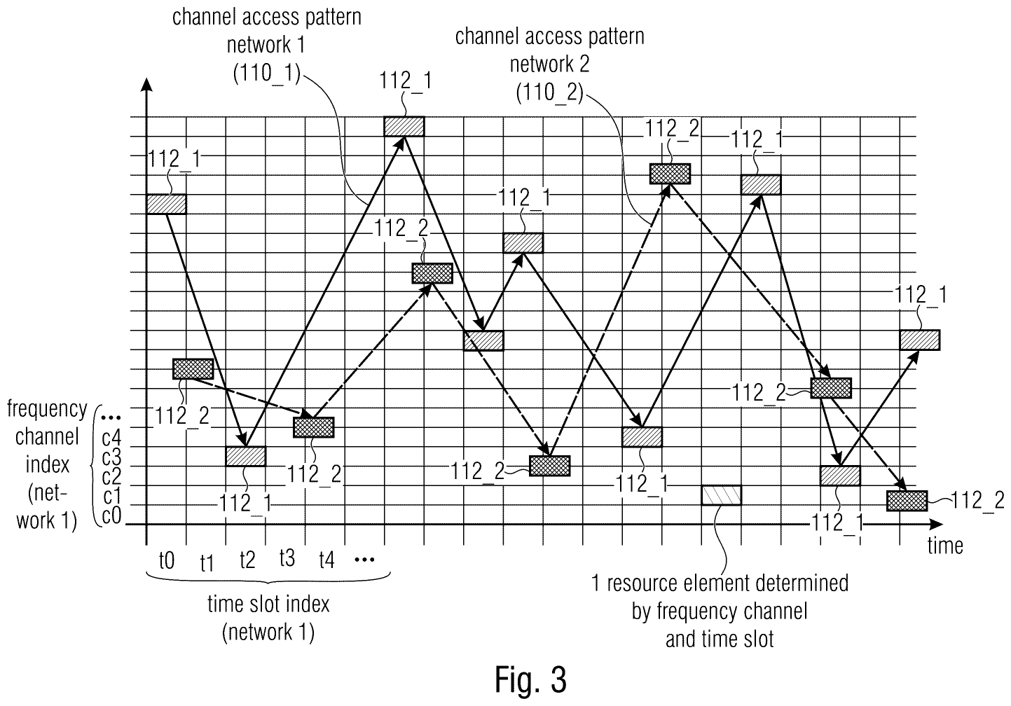

In the following, for illustrative purposes, beside the division of the frequency band into discrete frequency channels (indices c0, c1, c2, . . . ), what is assumed to be also carried out is a temporal discretization of the accesses within a respective network. The associated temporal resources are referred to as time slots and are provided in FIG. 3 with the indices t0, t1, t2, . . . . However, both requirements (discretization in frequency and time) are not necessary prerequisites for the application of embodiments.

In detail, FIG. 3 shows, in a diagram, a division of the frequency band into resources and a frequency hop-based and time hop-based occupancy of the resources of the frequency band defined by two different channel access patterns. Here, the ordinate describes the frequency channel indices and the abscissa describes the time slot indices.

For example, the participants of the first communication system 102_1 may wirelessly communicate among themselves on the basis of the channel access pattern 110_1, which indicates a frequency hop-based occupancy of resources of the frequency band to be used for the communication of the first communication system 102_1, whereas participants of the second communication system 102_2 wirelessly communicate among themselves on the basis of another channel access pattern 110_2, which indicates a frequency hop-based occupancy of resources of the frequency band, usable for the communication of the second communication system 102_2, wherein the channel access pattern and the other channel access pattern are different (e.g. comprise an overlap of less than 20%, not comprising any overlap in the ideal case).

In other words, FIG. 3 shows in grid form an overview of all fundamentally available resources in frequency and time (schematic illustration of the frequency channels and time slots and exemplary channel access patterns), wherein an individual resource element in the first communication network 102_1 is determined by allocation of a frequency channel index and a time slot index. As an example, the resources that can be occupied by the first communication network 102_1 are the resource elements indicated with the reference numeral 112_1. The set of all resources that can be occupied within a communication network represent a channel access pattern 110_1. For the first communication network 102_1, these are all resource elements indicated by the reference numeral 112_1 and connected via arrows. Equivalently, the channel access pattern of a further communication network (e.g. the second communication network 102_2) is exemplarily drawn in FIG. 3 (all resource elements indicated by reference numeral 112_2 and connected via arrows), which is not anchored in the same frequency grid and time grid as the first communication network 102_1 (resource elements are shifted in frequency and time from the base grid of the first communication system 102_1).

It is important to differentiate between
all fundamentally (maximum) available resource elements, i.e. the total quantity of all resource elements from which the channel access pattern selects an appropriate subset (e.g. all elements of the grid in FIG. 3),
all resource elements (in FIG. 3, all resource elements provided with the reference numeral 112_1) actually included into the channel access pattern, and
the quantity of resource elements (of the channel access pattern) that can actually be occupied in the network for a data transfer (e.g., with a low amount of data, only every third resource element available in the channel access pattern could actually be used).

The design of the channel access pattern therefore also means a determination of the actively usable resource supply for this communication network (or communication system).

Embodiments of base stations, terminal points, and/or communication systems using channel access patterns that fulfil at least one of the above-mentioned criteria a) to e) for communication are described in the following. In addition, embodiments of the generation of such channel access patterns are described in the following.

### A.1. Base Station, Terminal Point and Communication System

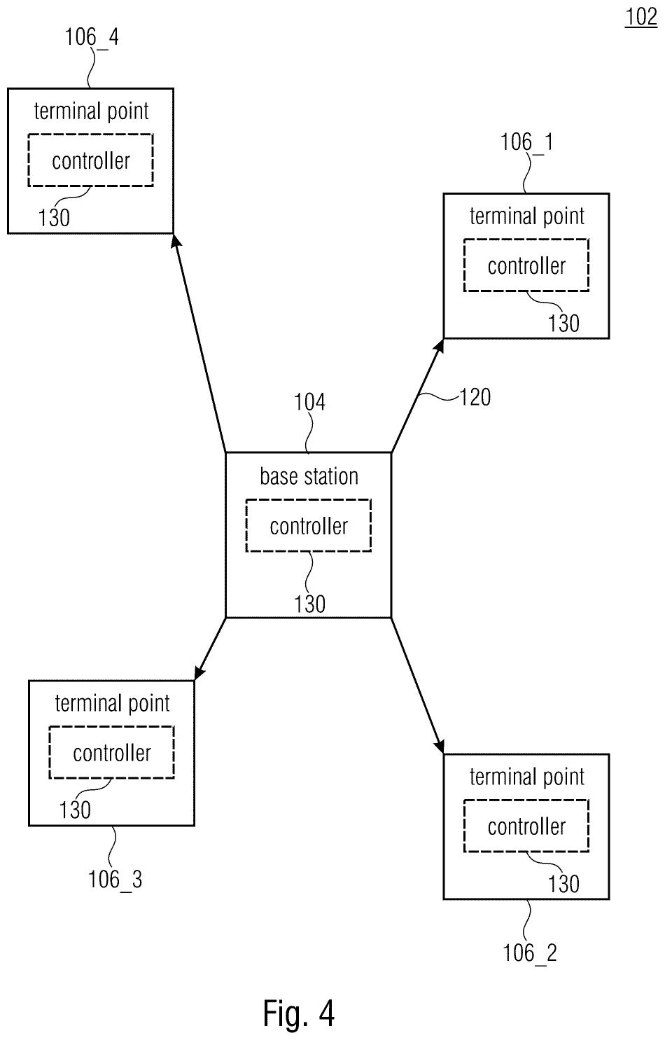

FIG. 4 shows a schematic block circuit diagram of a communication system 102 with one base station 104 and a plurality of terminal points 106_1-106_4, according to an embodiment.

As shown in FIG. 4 according to an embodiment, the communication system 102 may comprise one base station and four terminal points 106_1-106_4. However, the present invention is not limited to such embodiments, rather, the communication system may comprise one or several terminal points 106_1-106_n, wherein n is a natural number larger than or equal to one. For example, the communication system may comprise 1, 10, 100, 1000, 10,000, or even 100,000 terminal points.

The participants (=the base station 104 and terminal points 106_1-106_4) of the communication system shown in FIG. 4 use for mutual communication a frequency band (e.g. a license-free and/or permission-free frequency band such as the ISM bands) used for communication by a plurality of communication systems, as described above with reference to FIGS. 1 to 3. In this case, the communication system 102 operates in an uncoordinated manner with respect to the other communication systems that use the same frequency band.

In embodiments, the base station 104 may be configured to transmit a signal 120, wherein the signal 120 comprises information about a channel access pattern 110, wherein the channel access pattern indicates a frequency hop-based and/or time hop-based occupancy (e.g. of resources) of the frequency band, usable for the communication of the communication system 102 (e.g. a temporal sequence of frequency resources (e.g. distributed across the frequency band) usable for the communication of the communication system), wherein the information describes a state of a numerical sequence generator for generating a numerical sequence, wherein the numerical sequence determines the channel access pattern.

For example, the state of the numerical sequence generator may be an internal state of the numerical sequence generator, wherein a number of the numerical sequence may be derived from the internal state of the numerical sequence generator. On the basis of the internal state of the numerical sequence generator, internal states of the numerical sequence generator following the internal state of the numerical sequence generator may be identified, from which following numbers of the numerical sequence may also be derived. For example, the number of the numerical sequence may be directly derived from the internal state of the numerical sequence generator (e.g. state=number), e.g. in the implementation of the numerical sequence generator as a counter, or via a mapping function, e.g. in the implementation of the numerical sequence generator as a shift register, possibly with feedback.

In embodiments, at least one of the terminal points 106_1, 106_4 may be configured to receive the signal 120 with the information about the channel access pattern 110, and to identify the channel access pattern 110 on the basis of the information about the channel access pattern, wherein the information describes a state of a numerical sequence generator for generating a numerical sequence, wherein the numerical sequence determines the channel access pattern.

For example, the base station 104 and/or at least one of the terminal points 106_1-106_4 may be configured to pseudo-randomly identify the channel access pattern as a function of the state of the numerical sequence generator, e.g. by using a pseudo-random mapping function.

In addition, the base station 104 and/or at least one of the terminal points 106_1-106_4 may be configured to pseudo-randomly identify the channel access pattern as a function of individual information of the communication system (e.g. intrinsic information of the communication system such as a network-specific identifier).

Embodiments of the generation of channel access patterns are described in the following. In this case, the channel access patterns are generated by the base station 104 and may be identified by one (or all) of the terminal points 106_1-106_4 shown in FIG. 4 on the basis of the signal with the information 120 via the channel access pattern, e.g. by a controller (controlling device, controlling unit) 130 each, implemented into the base station 104 and/or into the terminal points 106_1-106_4. In this case, the specification of the channel access patterns is done (exclusively) by the base station 104, whereas the terminal points 106_1-106_4 only “know” the channel access pattern, i.e. they generate the same according to the same method as the base station 104.

The following description assumes a radio transfer system (or a communication arrangement) with several independent, mutually uncoordinated communication networks whose participants are in a mutual reception range so the transmission signals from participants of one network may potentially be considered as disturbance signals for participants of other networks. For the application of embodiments, it is not required to exchange information (data or signalization information) between different networks.

Likewise, it is irrelevant whether the networks are synchronized in time and/or frequency with respect to each other.

In addition, what is assumed is that, within each network, there is a coordinating instance (in the following referred to as “base station”) which may transmit to the non-coordinating participants of the network (in the following referred to as “terminal devices” or “terminal points”) information about the channel access pattern applied within the network. For example, this information may be transmitted via regularly emitted beacon signals, however, it may also be transferred in irregular intervals or, possibly, in a dedicated manner to individual terminal devices or groups of terminal devises.

In addition, what is assumed is that the entire frequency band available for the transfer is divided into a multitude of individual frequency channels that may each be accessed individually or in subsets (groups of frequency channels).

Without limiting the generality and for a better illustration, the following assumes that there is a fixed, discrete time pattern within each network with which channel accesses may be carried out (cf. FIG. 3). A channel access in the form of the emission of a signal may be carried out by terminal devices as well as by the base station. However, a channel access does not necessarily have to be carried out in a resource provided to this end in the channel access pattern, e.g., if there is no data or other information to be transferred.

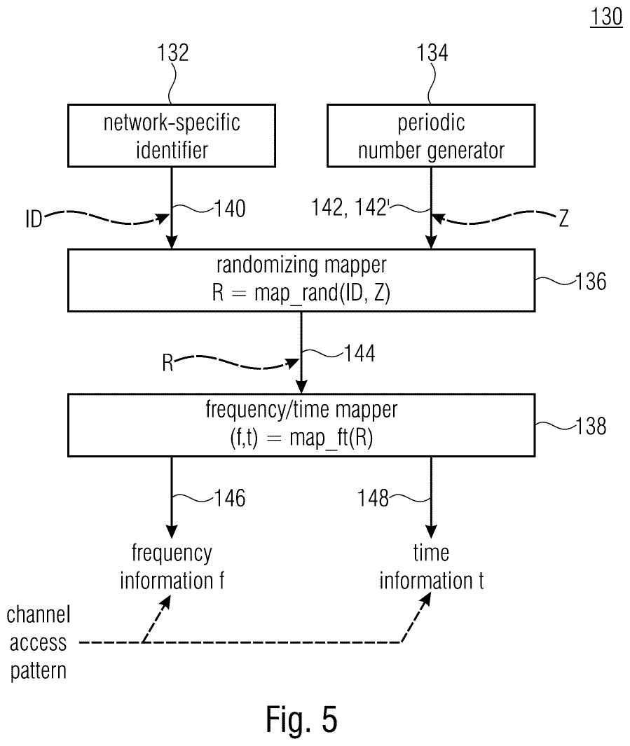

FIG. 5 shows a schematic block circuit diagram of a controller 130 for generating a channel access pattern, according to an embodiment of the present invention.

As can be seen in FIG. 5, the controller 130 may comprise a memory 132, a periodic number generator 134 for generating a periodic numerical sequence Z, a randomizing mapper 136 and a frequency/time mapper 138.

The memory (e.g. a register) 132 may be configured to store a network-specific identifier ID 140, e.g. a (individual) bit sequence that does not change. The periodic number generator 134 may be configured to provide its state 142 or a number 142′ of the periodic numerical sequence derived from its state. The randomizing mapper 136 may be configured to identify a pseudo-random number R144 as a function of the state 142 of the numerical sequence generator 134 or the number 142′ of the periodic numerical sequence derived therefrom and the network-specific identifier ID 140. The frequency/time mapper 138 may be configured to identify frequency information f 146 and time information t 148 on the basis of the pseudo-random number R 144. For example, the frequency information f 146 and the time information t 148 may describe, or define, a frequency channel and a time slot (or a frequency channel index and a time slot index) and therefore a resource of the channel access pattern.

For example—as is indicated in FIG. 4—the controller 130 may be implemented in the base station 104 and/or in the one or several terminal point(s) 106_1-106_4 so as to calculate the individual (or network-individual) channel access pattern used by the communication system 102.

In other words, FIG. 5 shows the base structure for the generation of channel access patterns according to an embodiment of the present invention.

The generation of the channel access patterns is done iteratively, i.e. the blocks illustrated in FIG. 5 are called up once per generation of a single piece of channel access information. By a call-up of N-times, a channel access pattern with N channel accesses is generated.

The function of the partial blocks is described in detail in the following. The term “number” is used. This is generally discrete information that may be present in different forms (e.g. in decimal form, as a binary sequence, or the like).

### Network-Specific Identifier “ID”

The network-specific identifier is a fixed number that is determined by an external instance (e.g. when configuring the network, or the coordinating base station). Ideally, it differs from network to network. For example, it may be an unambiguous, sufficiently long base station ID, unambiguous network ID, or a sufficiently long hash about them, respectively. This variable is fixed and is the only one that does not vary from call-up to call-up in the arrangement shown.

### Periodic Number Generator “Z”

The periodic number generator 134 generates a sequence of numbers Z that periodically repeats with the periodicity P. It has an internal state Sₙ from which the next generated number and the next internal state Sₙ₊₁ can be unambiguously determined. The significant feature is that the entire periodic sequence for each time step may be derived from a single internal state (which is present in an arbitrary time step) already. For example, a simple embodiment is a modulo P counter that periodically delivers the numerical sequence 0, 1, 2 . . . (P−1). A further embodiment is a deterministic random number generator (pseudo-random number generator), e.g. implemented in the form of a feedback shift register (LFSR). A third embodiment is a finite body (Galois field) with P elements.

### Randomizing Mapper

The randomizing mapper 136 generates from the two input numbers ID and Z an output number R, i.e. R=map_rand(ID, Z) wherein map_rand represents the mapping function. In this case, the mapping has as random a character as possible, i.e. a mathematically correlated input sequence (consisting of ID, Z) generates an output sequence R that is as uncorrelated in itself as possible.

Embodiments for a randomizing mapping are:
linking the two input numbers
applying a cyclic redundancy check (CRC) on the input qualities ID, Z, which leads to the number R and has a randomizing character,
applying a hash function
applying an encryption, e.g. AES encryption, wherein the associated key is known to all authorized participants, and which therefore also represents a method for embedding a “transport layer security” (TLS).

According to the above, the sequence of the elements of the number R is of a pseudo-random nature. It should be different from network to network so as to avoid overlaps of the channel access patterns.

### Frequency/Time Mapper

The frequency/time mapper 138 maps, by means of a mapping, to each input number R a 2-tupal of frequency information (radio frequency f) and time information (access time t), i.e. (f,t)=map_ft(R), wherein “map_ff” represents the mapping function. While, in principle, the sequence of the frequencies may be arbitrary within the specified frequency band, the points in time may be present in a monotonously increasing form from call-up to call-up, since “returns” in time are not admissible.

As an embodiment, what is of particular importance is the case in which the channel access is discretized in time/frequency direction (as described above), i.e. is done in the form of discrete frequency channels and discrete time slots. In this case, the frequency/time mapper allocates to each input number R a 2-tuple of frequency channel index fi and time slot index ti, i.e. (fi,ti)=map_ft(R). The time slots are indexed in a temporally ascending order, since “returns” in time are not admissible.

The sequence of the 2-tuple (f,t), or (fi, ti), is based on the sequence of the elements of R and defines the channel access pattern.

The exact implementation of the frequency/time mapper, together with the probability function of the number R, determines the access statistic with respect to the channel.

### State Signaling and Predictability

The arrangement shown in FIG. 5 generates a channel access pattern that depends both on a temporally invariable network-specific identifier and on a state-dependent (and therefore temporally variable) periodic number generator (periodicity P). By means of the network-specific identifier, it can be ensured that networks with different network-specific identifiers generate different sequences of R, even if their number generator were to be in the same state. This can ensure that different networks do not generate any identical channel access patterns and therefore, in the worst case, get into a “continuous collision” of the channel accesses.

In order to identify the channel access pattern used in the network, a terminal device needs the network-specific identifier and the respective state of the periodic number generator.

The network-specific identifier is obtained by the terminal device already at the initial log-on at the network. Advantageously, the same is transferred by means of beacon signals regularly emitted by the base station, and is made available to all authorized terminal devices. Alternatively, the network-specific identifier may also be made known to the terminal device in the course of the initial configuration (with delivery), i.e. before the first operation in the network. Alternatively, the network-specific identifier may also be transmitted to the respective participant in a separate message.

The state of the periodic number generator may either be transferred in a regular beacon signal and/or in distinct dedicated state-signaling resources. A number generator with a periodicity P has P internal states so that ┌log₂(P)┐ bits are transferred for the transmission of the respective state. The amount of information (number of bits) transferred per state signaling may therefore be controlled by the selected periodicity of the number generator according to the requirements.

The information transferred for the state signaling may be transferred in the form of several pieces of partial information, wherein the transfer may be carried out with different frequencies. Thus, as an embodiment for the case that the periodic number generator (Z) is a counter, the higher-valued bits (most significant bits (MSBs)) of the counter could be transferred separated from the lower-valued bits (least significant bits (LSBs)), and also with different frequencies (e.g. more infrequently). Even if it is not a counter, the entire state information could be transferred in the form of several pieces of partial state information with different transfer frequencies.

Through the periodicity of the number generator, a terminal device that knows the state of the number generator at least at one point in time may determine the entire channel access pattern for any points in time/time slots in the future. This enables the terminal device in an energy-saving idle state to deactivate, e.g., the transmission/reception unit and to predetermine the then valid portion of the channel access pattern from the last previously known state when the transmission/reception unit is subsequently activated. An emission of the state information by the base station may therefore be done in comparatively large temporal intervals.

In summary, the method described herein has the advantage that a comparatively large state space for the (pseudo-random) number R is covered through the combination of a network-specific identifier and a periodic numeric generator. This prevents the channel access patterns of networks to be identical with different network-specified identifiers, which may minimize a systematic collision of the channel accesses of different mutually uncoordinated networks. This proves to be particularly advantageous for the telegram splitting multiple access (TSMA) method.

Advantageous features of the frequency/time mapper are discussed in more detail in the following sections.

### Further Embodiment of the Controller

According to FIG. 5 and the above description, a periodic number generator 134 is needed. In the following embodiment, it is replaced as follows.

Real radio networks are often operated with a beacon signal that is emitted regularly. In this case, each beacon emission may be provided with a counter that corresponds to a beacon sequence index. Here, this beacon sequence index is referred to as “beacon index”.

It is also common practice for the time slots in a time slot-based system to be provided with a time slot index counter (that increases in the time direction) (cf. FIG. 3). Here, this is referred to as “time slot index”. The beacon index is reset to zero in certain intervals specified in the system so that it has a periodicity. The same applies to the time slot index (e.g. which restarts at zero after a beacon emission).

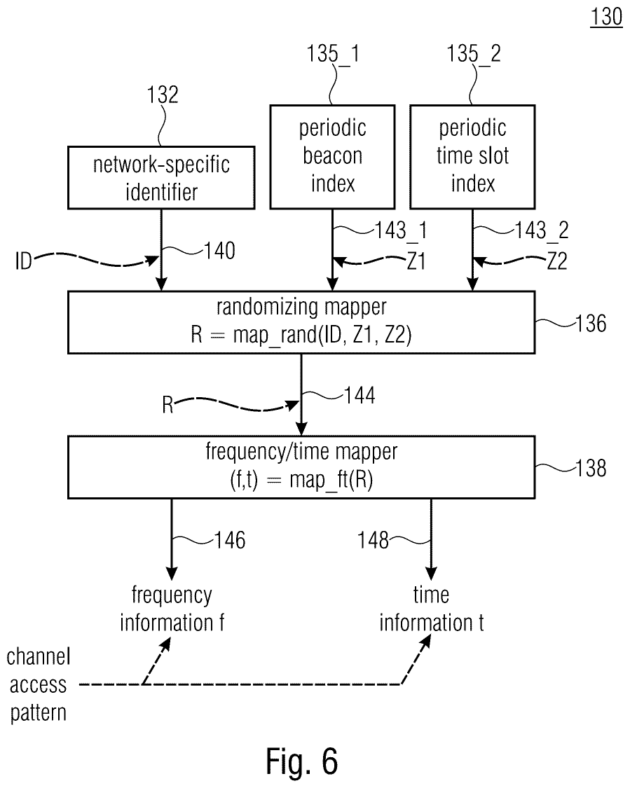

FIG. 6 shows a schematic block circuit diagram of a controller 130 for generating a channel access pattern, according to an embodiment of the present invention.

The controller 130 may comprise a memory 132, a first buffer 135_1, a second buffer 135_2, a randomizing mapper 136 and a frequency/time mapper 138.

The memory (e.g. a register) 132 may be configured to store a network-specific identifier ID 140, e.g. a (individual) bit sequence that is invariable. The first buffer (e.g. a register) 135_1 may be configured to store a periodic beacon index Z1 143_1. The second buffer (e.g. a register) 135_2 may be configured to store a periodic time slot index Z2 143_2. The randomizing mapper 136 may be configured to identify a pseudo-random number R 144 as a function of the periodic beacon index Z1 143_1, the periodic time slot index Z2 143_2 and the network-specific identifier ID 140. The frequency/time mapper 138 may be configured to identify frequency information f 146 and time information t 148 on the basis of the pseudo-random number R 144. For example, the frequency information f 146 and the time information t 148 may describe, or define, a frequency channel and a time slot (or a frequency channel index and a time slot index) and therefore a resource of the channel access pattern.

In other words, FIG. 6 shows a modified base structure for generating channel access patterns with a beacon index and a time slot index. FIG. 6 illustrates an embodiment in which, compared to the embodiment shown in FIG. 5, the periodic number generator (output Z) 134 is replaced by the two blocks “periodic beacon index” (output Z1) 135_1 and “periodic time slot index” (output Z2) 135_2. All further blocks are unchanged in function (the randomizing mapper now has three inputs).

The controllers 130 shown in FIGS. 5 and 6 enable the generation of network-individual channel access patterns, comprising at least one of the following characteristics:
the channel access patterns contain amongst themselves as few overlapping partial sequences as possible,
there is a large supply of channel access patterns (e.g. in areas with a high network density),
the channel access patterns are designed such that they have a very high periodicity,
the channel access patterns lead (if there are corresponding requirements) to an use of the available frequency channels that is uniform on average,
signaling of the applied pattern is done by the coordinating instance with as little signaling information as possible, and
terminal devices may already determine the content of the access pattern at any future time when the signaling of the channel access is received once and completely (this enables terminal devices, e.g. for energy saving reasons, to introduce longer reception pauses and to determine the valid channel access pattern on the basis of information received before the reception pause, when being switched on again.

### A.2. Control of the Channel Access in the Frequency Domain

To simplify the following illustration, what is assumed is that the frequency range (or the frequency band) is divided into discrete frequency channels and that a transfer is carried out according to the TSMA method.

Mobile radio channels usually comprise signal attenuation that varies across the frequency. If a data packet is transferred in the form of several partial data packets according to the TSMA method and if the underlying mobile radio channel is not known in the transmitter, the error rate of the transfer may be reduced or even minimized on average by transferring the individual partial data packets as distributed across the entire frequency domain as possible (using the frequency diversity).

For this reason, it may be advantageous (in particular if a data packet consists of only a few partial data packets) to ensure that the frequency channels on which the partial data packets are transferred have a certain (minimum) distance relative to each other in the frequency domain.

Since the channel access pattern significantly determines the frequency hopping behavior in TSMA within a network, a suitable method may be used to ensure that there is a minimum distance between two consecutive frequency channels of the channel access pattern.

Thus, in embodiments, the frequency/time mapper 138 (cf. FIG. 5 or 6) may be configured to determine frequency information f and time information t on the basis of the pseudo-random number R, wherein the frequency information f indicates a distance between two consecutive frequency channels.

Thus, the frequency/time mapper 138 in FIG. 5 or 6, which determines absolute frequency channels independently from access to access on the basis of the pseudo-random number R, may alternatively also determine distances between two consecutive frequency channels.

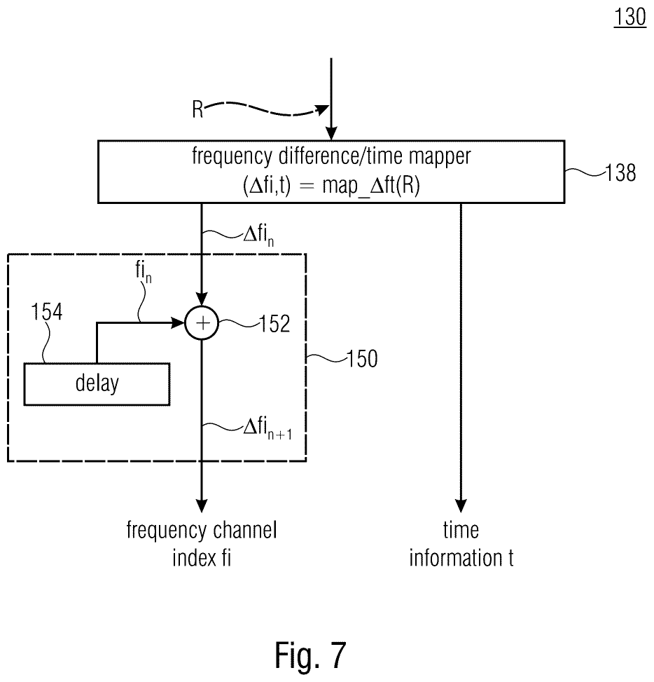

FIG. 7 shows a schematic block circuit diagram of a section of the controller 130, according to an embodiment. As can be seen in FIG. 7, the frequency/time mapper 138 (cf. FIG. 5 or 6) may be configured to determine frequency information and time information on the basis of the pseudo-random number R, wherein the frequency information indicates a distance Δfiₙ between two consecutive frequency channels.

As can further be seen in FIG. 7, the controller 130 may comprise a mapper 150 configured to map the distance Δfiₙ between two consecutive frequency channels onto a frequency channel index fi, e.g. by means of a combiner (e.g. adder) 152 and a delay element 154.

In other words, FIG. 7 shows the generation of frequency hops with minimum and/or maximum hop widths. FIG. 7 illustrates that the frequency/time mapper 138 of FIG. 5 or 6 is now replaced by a frequency difference/time mapper 138 that no longer provides absolute frequency channel indices at its immediate output, but frequency channel index differences.

By means of a suitable mapping function (Δfi,t)=map_Δft(R) in the frequency difference/time mapper, it may be ensured that only frequency channel index hops Δfiₙ=fiₙ₊₁−fiₙ (from channel access n to channel access n+1) are carried out, e.g., that are within a desired range, e.g. Δfiₘₐₓ≥Δfi≥Δfiₘᵢₙ for Δfi>0 and Δfiₘₐₓ≥(−Δfi)≥Δfiₘᵢₙ for Δfi<0. There are numerous methods for the implementation of such a limitation, which are not subject of the invention.

The following shows how one or several participants in a communication system 102 can transmit data by using the channel access pattern.

### B. Channel Access Via the Channel Access Pattern

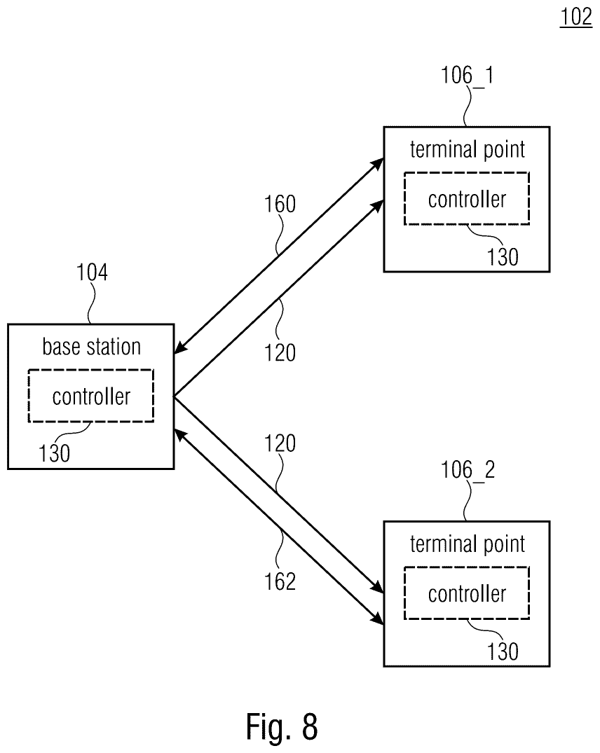

FIG. 8 shows a schematic block circuit diagram of a communication system 102 with one base station 104 and two terminal points 106_1-106_2, according to an embodiment of the present invention.

The communication system 102 shown in FIG. 8 comprises one base station 104 and two terminal points 106_1-106_2. However, the present invention is not limited to such embodiments, rather, the communication system 102 may comprise one or several terminal points 106_1-106_n, wherein n is a natural number larger than or equal to one. For example, the communication system may comprise 1, 10, 100, 1.000, 10.000, or even 100.000 terminal points.

As already explained in detail above (cf. FIG. 4, for example), the participants (=base station 104 and terminal points 106_1-106_2) of the communication system use for the mutual communication a frequency band (e.g. a license-free and/or permission-free frequency band, e.g. the ISM bands) used for communication by a plurality of communication systems. In this case, the communication system 102 operates uncoordinatedly with respect to the other communication systems that use the same frequency band.

As also explained in detail above, the base station 104 is configured to transmit a signal 120, wherein the signal 120 comprises information about a channel access pattern 110, wherein the channel access pattern 110 indicates a frequency hop-based and/or time hop-based occupancy of resource elements of the frequency band, usable for the communication of the communication 102, while the terminal points 106_1-106_2 are configured to receive the signal 120, and to determine the channel access pattern 110 on the basis of the information about the channel access pattern (cf. FIGS. 5 and 6, for example).

Here, a resource element can include one or several time slots and/or one or several frequency channels.

For mutual communication, i.e., for mutual transmission of data, the participants (e.g., base station 104 and terminal point 106_1) can use a proper subset of the resource elements indicated by the channel access pattern 110, such as i resource elements of the channel access pattern, wherein i is a natural number greater than three such as 3, 4, 5, 10, 15 or 18.

In detail, in embodiments, the base station 104 can be configured to transmit and/or receive data 160 (e.g., a signal with the data 160) by using a proper subset of the occupancy of resource elements indicated by the channel access pattern. Accordingly, the terminal point 106_1 can be configured to transmit and/or receive data 160 (e.g., a signal with data 160) by using a proper subset of the occupancy of resource elements indicated by the channel access pattern.

Here, the data can be divided into a plurality of sub-data packets and can be transmitted by using the channel access pattern. In one resource element each of the channel access pattern, one sub-data packet can be transmitted, for example when the resource element includes a time slot and/or a frequency channel. Obviously, several sub-data packets can be transmitted per resource element of the channel access pattern, for example when the resource element includes several time slots and/or frequency channels.

For example, the data (e.g., a data packet or telegram) can be divided into j sub-data packets, wherein j is a natural number greater than three, such as 3, 4, 5, 10, 15 or 18. Here, for transmitting the sub-data packets, j=i resource elements of the channel access pattern can be used, such that one sub-data packet each of the plurality of sub-data packets is transmitted in a resource element. Obviously, also more than one sub-data packet of the plurality of sub-data packets can be transmitted per resource element, such as two, three or four sub-data packets. On the receiver side, the sub-data packets or at least a proper subset of the sub-data packet can be assembled or combined again to obtain the data.

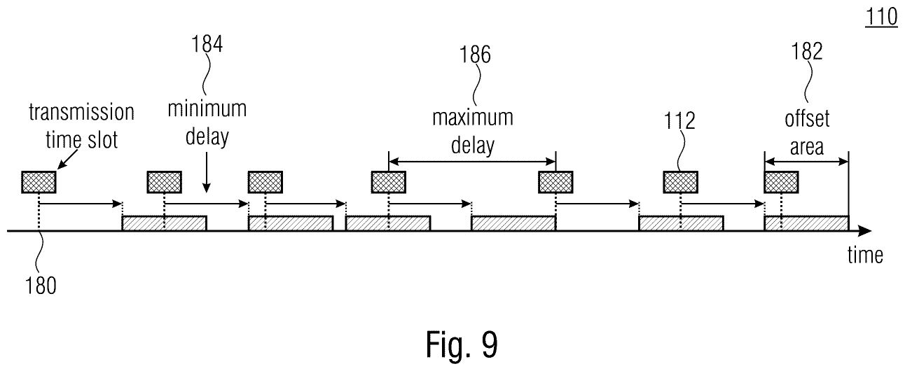

In order to increase the interference immunity more, the resource elements of the channel access pattern and hence also the sub-data packets that are transmitted in the respective resource elements of the channel access pattern can comprise a pseudo-random offset in time as will be discussed below based on FIG. 9.

In detail, FIG. 9 shows in a diagram a schematic view of a sequence of instants 180 defining a temporal position of the resource elements 112 of the channel access pattern 110, wherein the instants 180 are pseudo-randomly distributed within respective time periods 182, that are each defined by a predetermined minimum time interval 184 and a predetermined maximum time interval 186 at an immediately preceding instant of the sequence of instants 180, according to an embodiment of the present invention. Here, in FIG. 9, the abscissa describes the time. The instants can coincide with time reference points of the resource elements 112. In FIG. 9, it is exemplarily assumed that the time reference points (or reference times) are the middle of the respective resource elements. The time reference points can also be start or end of the resource elements or also any other instant within a resource element.

Thus, section A and section B describe a communication system in which a beacon is emitted at certain intervals and between the beacons downlink messages can be sent to a node. Due to the advantageous properties, this approach also uses the telegram splitting method having a non-transmission period between individual sub-data packets. For this, a so-called resource element grid (in other words a template for the sub-data packets) is used, from which the position of the sub-data packets can be derived (e.g., with the help of further parameters, such as BS-EUI and a counter).

In the following, it is described how the latency in the downlink (i.e., for transmissions from the base station to one or several nodes) can be reduced further when using a second channel access pattern.

c. Additional Channel Access Pattern with Low Latency

In embodiments, the channel access pattern described in sections A and B can be a first channel access pattern.

Here, the participants (e.g., base station 104 and terminal point 106_1) of the communication system can be configured to operate in a first mode (e.g., mode with normal latency) and in a second mode (e.g., mode with low latency). Here, the first channel access pattern for the first mode can be determined based on the information on the first channel access pattern, for example as described above in section A.

The first channel access pattern can allow data transmission with normal latency.

According to the concept of the present invention, for realizing data transmission with low latency, a second channel access pattern is introduced for the second mode, which allows data transmission with lower latency than the first channel access pattern.

In embodiments, the second channel access pattern can also be determined based on the information on the first channel access pattern, which is emitted anyway by the base station by means of the signal 120, such that there is no additional overhead for the second channel access pattern.

For example, the first channel access pattern can be determined from the information on the first channel access pattern via a first mapping rule, for example, as described above in section A, while the second channel access pattern can be determined from the information on the first channel access pattern via a second mapping rule, wherein the first mapping rule and the second mapping rule are different.

In embodiments, a resource element each of the second channel access pattern can include one or several time slots and/or one or several frequency channels.

In embodiments, in one resource element each of the second channel access pattern, one sub-data packet can be transmitted, for example when the resource element includes a time slot and/or a frequency channel. Obviously, also several sub-data packets can be transmitted per resource element of the channel access pattern, for example, when the resource element includes several time slots and/or frequency channels, wherein one sub-data packet can be transmitted per time slot/frequency channel.

In the following, detailed embodiments of the present invention will be described in more detail.

### C.1 Using the Channel Access Pattern of Section A and B for Further Communication

In order to obtain a latency of less than one (1) second, it is commonly needed that a node (or terminal point of the communication system) searches for a new message with the receiver at least once per second. Here, the current consumption as mentioned above will increase heavily, such that this is only possible for nodes with large batteries and shorter battery lifespan or nodes with external current supply.

The system described in section A and B uses a resource grid with average intervals between the sub-data packets of approximately 50 ms to 500 ms. The maximum transmission duration of a sub-data packet is at approximately 25 ms.

This results in breaks between the sub-data packets where no transmission takes place. According to embodiments, these breaks are used for transmissions that need a latency of less than one (1) second. Thus, nodes supporting this “ultra-low-delay” mode have to be registered in the system described in section B so that they know the position of the resource grid, the resource elements (RE, in FIG. 9 indicated by reference number 112) and hence also the breaks. In these breaks, at a defined time interval (offset) after the resource grid or after the actual transmission slot (e.g., transmission time of the sub-data packet or the resource element according to section B, also called radio burst), transmission of the ultra-low-delay telegram can start.

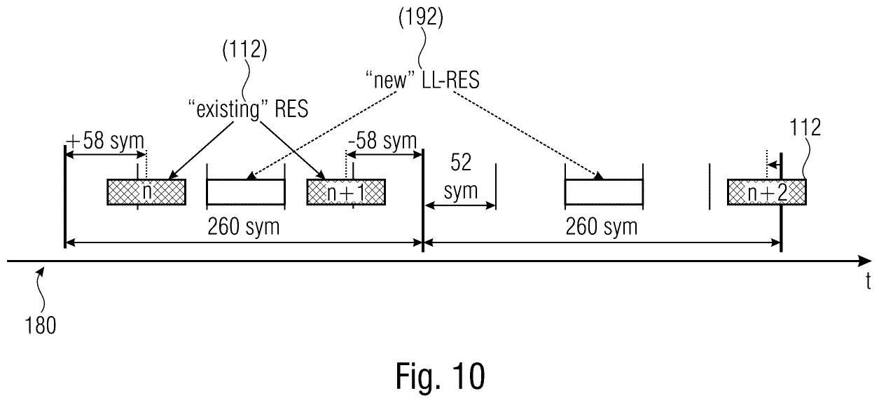

FIG. 10 shows in a diagram a schematic view of the resource elements 112 of the first channel access pattern as well as the resource elements 192 of the second channel access pattern, wherein the resource elements 192 of the second channel access pattern are between the resource elements of the first channel access pattern according to an embodiment of the present invention. Here, in FIG. 10, the abscissa describes the time. In other words, FIG. 10 shows an exemplary scheme for inserting ultra-low-delay sub-data packets between existing sub-data packets according to section A.

In embodiments, a temporal position of the resource elements 112 of the first channel access pattern 112 can be defined in relation to a periodic grid 188. Thus, the resource elements 112 of the first channel access pattern as indicated in FIG. 10 can comprise a temporal pseudo-random offset with regard to the periodic grid 188, such that, for example, the resource elements 112 of the first channel access pattern are within predetermined time ranges around the respective grid positions of the periodic grid 188.

For example, a temporal position of the resource elements 112 of the first channel access pattern can be defined by a sequence of instants relative to the periodic grid, wherein the instant of the sequence of instants is defined such that time intervals between immediately successive instants of the sequence of instants are distributed pseudo-randomly between a minimum time interval and a maximum time interval, and such that the instant of the sequence of instants is within predetermined time ranges around the respective grid positions. Time reference points of the resource elements 112, such as, for example, start, middle or end of the respective resource elements 112 can here coincide with the instant of the sequence of instants.

In the embodiment shown in FIG. 10, it is exemplarily assumed that the interval between grid points of the periodic grid is 260 symbol durations, wherein a first resource element comprises a time offset to the periodic grid of +58 symbol durations, while a second resource element comprises a time offset to the periodic grid of −58 symbol durations. However, the invention is not limited to such embodiments. Rather, the interval between grid points of the periodic grid can also assume completely different values. As non-limiting examples, values of 10, 20, 30, 40, 50, 100, 200, 300, 400, 500, 1000 etc. symbol durations are stated or value ranges of 50 to 500 or 10 to 1000 symbol durations. Here, the time offset to the periodic grid can also assume completely different values.

In other words, FIG. 10 shows a schematic view of inserting new transmission time slots (LL-RE=low-latency resource elements) between the resource elements (RE); transmission instants of the sub-data packets according to section B) as well as the resource grid. In FIG. 10, the position of the transmission time slots (LL-RE) with (ultra-) low latency is exemplarily made dependent on the resource grid. Obviously, it would also be possible to make the transmission time slots (LL-RE) with (ultra-) low latency dependent on the instants of the sub-data packets according to section B.

In embodiments, the position of the transmission time slots with ultra-low latency is made dependent on another system/transmission mode of the system and therefore no further synchronization of the participants for the mode with ultra-low latency is needed and no further data have to be transmitted for coordination.

As the system described in sections A and B uses the telegram splitting method with pseudo-random instants and frequencies, in embodiments, these pseudo-random instants and/or frequencies can also be used for the ultra-low delay sub-data packets, as the interference immunity is still given by random time jitter and/or frequency offset.

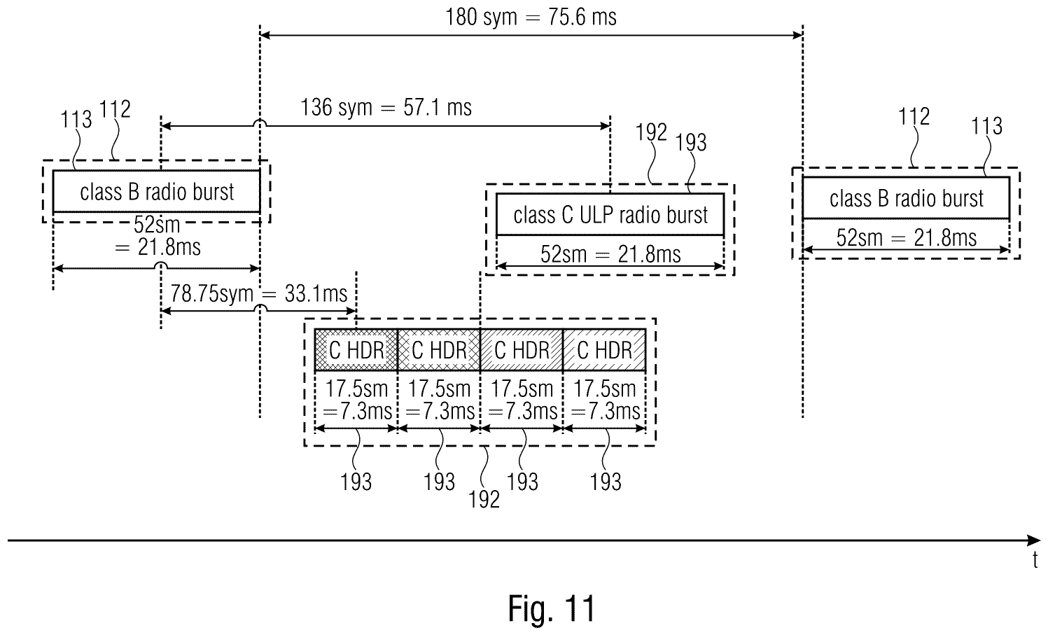

FIG. 11 shows a schematic view of a position of the resource elements 112 of the first channel access pattern (e.g., channel access pattern with normal latency) and the resource elements 192 of the second channel access pattern (e.g., channel access pattern with (ultra-) low latency) according to an embodiment. Here, in FIG. 11, the abscissa describes the time.

As can be seen in FIG. 11, one or several resource elements 192 of the second channel access pattern can be arranged between the resource elements 112 of the first channel access pattern, wherein a reference point of a respective resource element of the second channel access pattern comprises a fixed time interval to a reference point of a respective resource element of the first channel access pattern.

In embodiments, in the resource elements 112 of the first channel access pattern, one sub-data packet 113 each with normal latency can be transmitted. The sub-data packet 113 with normal latency can also be referred to, for example, as class B sub-data packet (class B radio burst).

In embodiments, in the resource elements 192 of the second channel access pattern 192, one sub-data packet 193 each with (ultra-) low latency can be transmitted. As long as one sub-data packet 193 with (ultra-) low latency is transmitted per resource element 192, this sub-data packet can also be referred to, for example, as class C sub-data packet with low energy requirements (class C ULP (ULP=ultra-low power) radio burst). A reference point of a resource element 192 of the second channel access pattern in which only a sub-data packet 193 with (ultra-) low latency is transmitted, can for example have a fixed time interval of 126 symbol durations or 57.1 ms to a reference point of an immediately preceding resource element 112 of the first channel access pattern. In other words, a reference point of a sub-data packet 193 with (ultra-) low latency can comprise, for example, a fixed time distance of 136 symbol durations or 57.1 ms to a reference point of an immediately preceding sub-data packet 113 with normal latency. Obviously, the fixed time interval can also comprise another value, such as 40, 50, 60, 70, 80, 90, 100, 110, 120, 130, 140, 150, or 160 symbol durations. Here, the reference points can, for example, be each in the middle of the resource elements or sub-data packets.

Alternatively or additionally, several sub-data packets 193 with (ultra-) low latency can be transmitted in the resource elements 192 of the second channel access pattern, such as 2, 3 or 4 sub-data packets with (ultra-) low latency. In this case, a resource element 192 of the second channel access pattern can include several time slots, wherein one of the sub-data packets 193 with (ultra-) low latency is transmitted per time slot. If several sub-data packets 193 with (ultra-) low latency are transmitted per resource element 192, these sub-data packets can also be referred to, for example, as class C sub-data packet with high data rate (class C HDR (HDR=high data rate) radio burst). A reference point of a resource element 192 of the second channel access pattern in which several sub-data packets with (ultra-) low latency are transmitted, can have, for example, a fixed time interval of 78.75 symbol durations or 33.1 ms to a reference point of an immediately preceding resource element 112 of the first channel access pattern. In other words, a reference point of a first sub-data packet 193 with (ultra-) low latency of the several sub-data packets with (ultra-) low latency can comprise, for example, a fixed time interval of 136 symbol durations or 57.1 ms to a reference point of an immediately preceding sub-data packet 113 with normal latency. Obviously, the fixed time interval can also have a different value, such as 40, 50, 60, 70, 80, 90, 100, 110, 120, 130, 140, 150, or 160 symbol durations. Here, the reference points can be, for example, in the middle of the resource element 112 of the first channel access pattern and in the middle of a first slot (in which is a first sub-data packet with (ultra-) low latency) of the resource element 192 of the second channel access pattern or in the middle of the sub-data packet 113 with normal latency and in the middle of a first sub-data packet 193 with (ultra-) low latency of the several sub-data packets with (ultra-) low latency.

In other words, FIG. 11 shows a schematic view of an exemplary link of a system according to sections A and B (in FIG. 11 indicated as a sub-data packet 113 with normal latency (class B radio burst)) and the new resource elements with low latency (LL-RE) (in FIG. 11 indicated as sub-data packets 193 with (ultra-) low latency (class C ULP radio burst and class C HDR radio burst)). As can be seen in FIG. 11, the time interval depends only on the preceding sub-data packet (or radio burst) (or resource element) of sections A and B and has a fixed distance of 136 or 78.75 symbol durations.

In FIG. 11, there are two different intervals to the preceding resource element according to sections A and B, as different data rates (e.g., a first data rate called ULP (ULP=ultra-low power) and a second data rate called HDR (HDR=high data rate), which can also be used in parallel, are possible for the new resource element with low latency (LL-RE).

In embodiments, the interval to the preceding sub-data packet (or radio burst) of sections A and B is fixed by 136 or 78.75 symbol durations (reference to the ULP data rate).

In a similar manner to the time slots, the frequency of the preceding resource elements of sections A and B can also be used for the new resource elements with low latency (LL-RE). It is possible to directly use the same frequency or to determine a frequency offset. If the same bandwidth is to be used, in a frequency offset, those frequencies have to be cyclically shifted back to the usable range.

In embodiments, the carrier frequency is equal to the preceding sub-data packet (or radio burst) of sections A and B or has a defined interval (or offset) to the same.

If the same frequency or the same frequencies shifted by an offset are used and the bandwidth is to be the same as in sections A and B, this principle only works when the data rate or symbol rate is smaller than or equal to the data rate of section A. If the data rate is higher, this principle cannot be applied, as the modulation bandwidth is greater at higher data rates or symbol rates and hence more bandwidth is needed.

Therefore, a different scheme for determining the data rates has to be used for higher data rates. One option would be to shift the frequencies at the band limits into the allowable range by means of a modulo operation; however, this results in an uneven utilization of the frequencies.

Since all participants have to receive the system or the mode according to sections A and B for time coordination, the same also know the parameters for calculating the channel access pattern (e.g., instants or time slots and the frequency channels). Thus, at higher data rates for the resource elements with low latency (LL-RE), with the parameters for calculating the channel access pattern according to section A and B, a second mapping rule can be determined, which is used only for the resource elements with low latency (LL-RE) at higher data rates. This rule can here be interpreted such that even utilization across all frequencies is obtained.

In embodiments, at higher data rates, a new mapping rule can be used that operates with the parameters for calculating the channel access pattern according to sections A and B. Thus, no additional transmission of parameters is needed for calculating the frequencies at higher data rates.

If the telegram splitting method is also to be used for the ultra-low-delay mode, several transmission time slots 192 with low latency (LL-RE), shown in FIG. 10, can be used for one message. With an exemplary usage of five transmission time slots 192 for the (ultra-) low latency sub-data packets, a latency of approximately 500 ms results when the average distances of the resource grid are 100 ms.

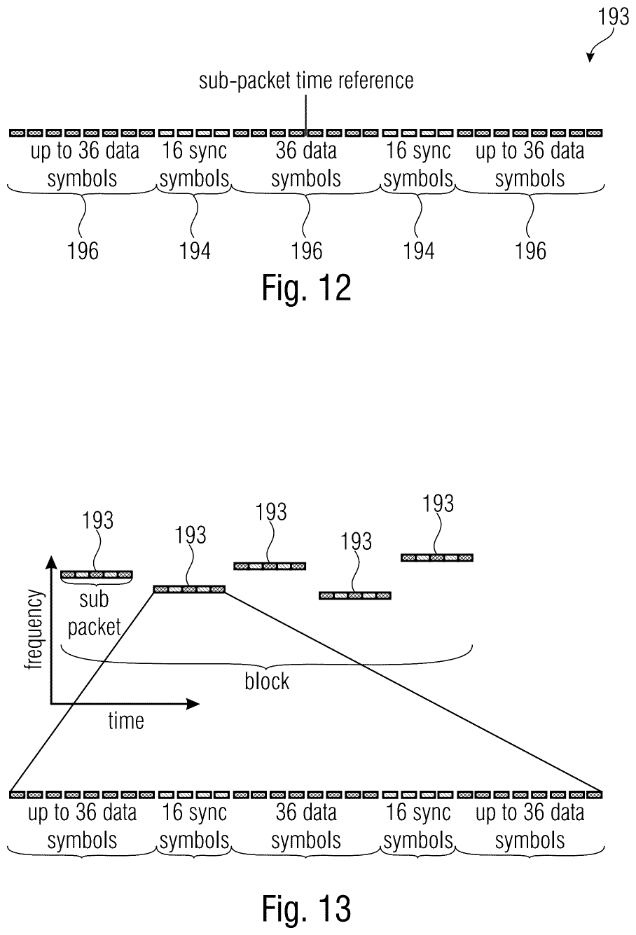

FIG. 12 shows a schematic view of a structure of a sub-data packet 193 with (ultra-) low latency. As can be seen in FIG. 12, the sub-data packet 193 comprises two synchronization sequences 194 having a length of 16 symbols, wherein a data block having a length of 36 symbols is arranged between the two synchronization sequences 194. Optionally, data blocks, each having up to 36 symbols, can be present before and after the synchronization sequences 194. Then, the sub-data packet 193 can include a maximum of 140 symbols, wherein 32 symbols thereof are allotted to the pilot sequences.

In other words, FIG. 12 shows a possible structure of a sub-data packet 193 with (ultra-) low latency. If five such sub-data packets would result in the entire data packet, up to 540 data symbols could be transmitted. With a code rate as in [1], this corresponds to approximately 22 byte payload data. If length information and CRC (cyclic redundancy check) are also used for error recognition, just under 20 byte of payload data remain. Similar to [1], the synchronization sequence can be derived from known information, wherein this process is described in more detail in section C.4. Alternatively, a fixed synchronization sequence can be defined.

If more than the mentioned just under 20 byte are to be transmitted, the telegram can be combined into several blocks of, e.g., five sub-data packets 193 each, similar as it is performed in [1] for the downlink, there, however, in blocks of 18 sub-data packets each. The scheme of a block can be structured, for example, as in FIG. 13.

In detail, FIG. 13 shows in a diagram a schematic view of an occupancy of a communication channel when transmitting five sub-data packets 193 with (ultra-) low latency. Here, the ordinate describes the frequency and the abscissa the time.

In embodiments, the sub-data packets 193 with (ultra-) low latency (or the first mode) can include more symbols than the sub-data packets with normal latency (or the second mode). This results in a longer transmission duration for the sub-data packets 193 with (ultra-) low latency than for the sub-data packets with normal latency. If the break between the sub-data packets with normal latency is not sufficient for that, the data rate of the sub-data packets with (ultra-) low latency can be set accordingly higher.

In embodiments, several time slots having ultra-low latency can be used together for one data packet consisting of several sub-data packets with (ultra-) low latency. Here, a new sub-data packet can be transmitted in each time slot.

In embodiments, the data rate of the sub-data packets with (ultra-) low latency can be different than the data rate of the sub-data packets with normal latency.

Here, it is shown in FIG. 11 that in the HDR data rate up to four sub-data packets (or radio bursts) can be transmitted in one resource element (RE). This can be used either for four parallel transmissions to different participants or for the embodiment described in section C.2 for fewer participants.

In embodiments, several sub-data packets (or radio bursts) can be transmitted at the HDR data rate within a resource element (RE) (of the second channel access pattern).

### C.2 Connected Repetition of the Sub-Data Packets and Early Decoding

By introducing the telegram splitting method with the sub-data packets with (ultra-) low latency in section C.1, the interference immunity of the transmission is increased at the expense of the latency of the transmission. If, however, as in [1], an error protection code with higher redundancy is introduced (in [1], the code rate is 1/3), with sufficient SNR (signal-to-noise ratio) and without interference, early decoding of the sub-data packets after receiving a (proper) subset of the sub-data packets is possible. This so-called early decoding allows reduction of the latency if the SNR is sufficiently good and not too many interferences are included in the received sub-data packets.

In section C.1, in each possible time slot, a maximum of one sub-data packet each was transmitted. If, for example, the five sub-data packets of section C.1 and a code rate of 1/3 as in [1] and an interleaver that distributes the information equally to all sub-data packets are assumed, early decoding would already be possible after two received sub-data packets. According to section C.1, the latency could then be reduced from five time slots to two time slots under the assumption that the SNR is sufficient and the interferences are not too present.

By varying the data rate as in section C.1, despite a higher number of symbols per sub-data packet, a lower transmission time results, this also provides the option of repeating the sub-data packets in the time slots, i.e., to transmit more than one sub-data packet per time slot. See, for example, FIG. 11, where up to four sub-data packets (corresponds to the time slots) are transmitted in one resource element.

Here, it is useful to not repeat the same sub-data packet in one time slot, but a different one. Useful interleaving of the sub-data packets based on five sub-data packets per block is shown in Table 1.

TABLE 1
Advantageous combination of the repeated sub-data
packets for five sub-data packets per block

| Number s at the | Sub-data packet | Sub-data packet |
|---|---|---|
| Exit of the | Number for First | Number for Repeated |
| Interleaver | Emission i | Emission r |
| 0 | 0 | 3 |
| 1 | 1 | 4 |
| 2 | 2 | 0 |
| 3 | 3 | 1 |
| 4 | 4 | 2 |

By the interleaved repetition of the sub-data packets, by using the code rate of [1] and for five sub-data packets, the option of trying early decoding already after receiving only one time slot is provided.

Here, the latency of section C.1 can be reduced to one time slot. If the SNR is not sufficient or an interference occupies the channel, further decoding can be performed, for example, after two time slots. In case the SNR is at the limit of decodability, decoding will only be successful after receiving all sub-data packets by using the full redundancy.

By dividing a block into five sub-data packets, for example, and by the optional complementary repeated emission within a time slot, despite the telegram splitting method, with good receiving conditions, a latency as in a system that does not divide the data packets can be obtained.

In embodiments, in each time slot, one or optionally several sub-data packets of the same receiver can be transmitted.

In embodiments, the receiver can perform early decoding already after two received sub-data packets, depending on the code rate and the number of sub-data packets per block. If decoding is successful, reception of this data packet can be terminated, otherwise further sub-data packets are waited for.

Example: one transmission needs five sub-data packets that are to be transmitted in five time slots. If the time slots A B C D E F are available, emission can start in each of the elements, not only at the start of a specific time slot.

The receiver checks all combinations whether emission has taken place:

Here: ABCDE and BCDEF.

This includes all possible combinations even beyond the limits of the system of section A.

### Example

A0 B0 C0 D0 E0 F0 A1 B1 C1 D1 E1 F1 . . . .

Emission can, for example, start in E0, then the same occupies E0 and F0 of the first block and A1, B1 and C2 from the second block.

Again, the receiver checks all combinations.
A0B0C0D0E0,
B0C0D0E0F0,
C0D0E0F0A1, . . .
   C.3 Latency Vs. Computing Effort/Current Consumption

In the previous sections C.1 and C.2, the goal was to reduce the latency to a minimum in order to obtain respective application cases with very high latency requirements. With the embodiment described in section C.2, even a latency of less than 100 ms is possible depending on the distances of the resource elements in section A. However, this is at the expense of the current consumption as stated above.

However, there are also applications having a latency requirement of only a few seconds (e.g., one to three seconds), which, however, cannot be fulfilled by the system of sections A and B.

In the mode with (ultra-) low latency, a very low latency is possible when the start of a telegram is possible in each time slot. Nodes (or terminal points) with little hardware resources, such as CPU/RAM/battery, are not able to let several detecting and/or decoding operations run in parallel. These nodes only search for telegrams with a start in each x-th time slot. In the above examples, after every fifth time slot, no parallel decoding is needed anymore. This is communicated accordingly when registering the node at the base station.

In embodiments, specific nodes with low hardware resources and/or nodes with not very strong latency requirements can start a new message only in each x-th time slot. This is communicated when registering the node at the base station.

Exemplarily, a system with low latency (LL-RE system) with 18 sub-data packets per block and the data rate as in [1] is assumed. Thereby, if the emission can start at each time slot, 18 detections have to be started after each reception of a time slot (RE) and in the worst case scenario up to 18 decoding processes. If the start can only be in each 18-th resource element (time slot), only one detection and possibly one decoding has to be performed every 18 resource elements.

If one participant is also addressable via the system of sections A and B, the same possibly has to perform detections and decoding there as well. If a detection of sections A and B is incidentally in the same time slot, according to section C.1, only very few symbol durations remain until the detection of resource elements with low latency (LL-RE) has to start.

This time requirement for the computing power can typically not be fulfilled in the receiver. To circumvent this, in embodiments, the times at which a message can start can be linked to the times of sections A and B and can be added to an offset for shifting.

If the system of sections A and B has a block size of, for example, 36 resource elements (RE), the detection typically takes place after 36 resource elements (RE). If the system shown herein with low latency (LL-RE system) has a block size of 18 resource elements (RE), the start of a new block can be at index 9 or at index 27, so that the distance to the system of sections A and B is improved or even maximized.

In embodiments, a new message can only start in each x-th time slot, wherein this time slot depends on the system of sections A and B. This time slot (RE) can be selected such that the time interval between the detection processes of the different modes is as large as possible.

### C.4 Addressing Via Participant-Specific Preamble & Indirect Addressing Via Keys

[1] describes a method, wherein the CMAC (one-key message authentication code) from the uplink is introduced into the downlink as authenticating part in the synchronization sequence. Thereby, an uplink message can be directly acknowledged without any further data, as this CMAC is only known to the transmitter and the receiver (or a group of receivers).

As there is no allocation of resources to specific nodes as section A by beacons in the mode with (ultra-) low latency, each participant has to calculate a new synchronization for each possible time slot and possibly evaluate a decoding even when the message is intended for another node. This results in large current consumption the greater the network, i.e., the more nodes use the mode with (ultra-) low latency.

In embodiments, this problem can be circumvented by using part of or the entire address of the participant or a characteristic (e.g., hash) derived from the address as pilot sequence. This information is unique for each node and hence other nodes can terminate reception already during synchronization. For this method to function even with low SNR, the address of the participant can be protected with the same FEC (FEC=forward error correction) as the data to be transmitted, so that the error probability of the address is not worse than the one of the data.

In embodiments, the address cannot only be known to the transmitter and the receiver or a group of receivers, in contrary to the concept of [1] with authenticated receipt confirmation, but the address can be encrypted like the subsequent payload data so that no conclusions can be drawn.

In embodiments, a part of or the entire address of the participant or a characteristic (e.g., a hash) derived from the address can be used as pilot sequence. Here, the address can be encrypted and/or an encoding on the address can be introduced for error protection.

If only part of the address or no address is inserted into the pilot sequence, the residual part of the address can be transmitted in the payload data so that the nodes can be sure that the message is intended for them.

If the data are encrypted, in a similar manner to [3], here also part of or the entire address can be implicitly transmitted by means of encryption without any further data.

In combination with introducing part of the address into the pilot sequence, both methods result in the option of completely omitting additional transmission of the address of the participant.

In embodiments, part of or the entire address of the participant is not transmitted and is implicitly given by the encryption.

5. Counter for Encryption is Derived from Another Mode or System

As described in [1], for encrypting data apart from the key, a counter or the same can be used, which changes in specific intervals in order to be able to prevent, for example, replay attacks. The counter used for encryption has to be known both to the transmitter and the receiver prior to evaluating the encrypted data. In [1], for this, in the uplink, the counter is transmitted in an unencoded manner together with the data. In the downlink, the same counter as in the preceding uplink is used. Here, in section B, the existing beacon counter is used. The same is known to the base station and all participants, as the same is needed for calculating the channel access pattern. Thus, in section 2, no further information on a counter has to be transmitted.

For the system suggested herein with (ultra-) low latency or the mode with (ultra-) low latency, also, a counter is needed for encryption. As described in section C.1, as the instants of the resource elements with low latency (LL-RE) are made dependent on the instant of the channel access pattern according to section A, a participant who wants to use the system with (ultra-) low latency also has to be registered in the system according to section A. Thus, the participant also knows the beacon counter or another counter of the system according to section A. The same can therefore also be used for encryption. In order to ensure the independence regarding the re-utilization of the counter between the two systems, further initialization information of the encryption are selected differently, for example, by setting an extra bit for the mode with low latency.

In embodiments, a counter of another system or mode can be used for encryption. Thereby, the additional transmission of a counter can be prevented, which reduces the overhead.

As mentioned in the introduction, the time span between two beacons can be in the range of 30 seconds to 5 minutes. Thus, the beacon counter also varies only within this interval. If more than one message is to be transmitted to the same participant within this interval, the same counter can be used for all messages in this interval. Thus, there is the option of being hit by replay attacks or known-plaintext attacks within this interval between two beacons.

This can be prevented by inserting and transmitting an additional small counter, which is reset again at the start of each new beacon. Here, the maximum size of the counter is at the maximum number of messages to be expected in the interval between two beacons. Due to this additional counter, the amount of information to be transmitted increases, but the bit depth of the additional counter is lower than when not using the beacon counter at all.

In embodiments, apart from the counter of the other system, a further counter can be used that is reset after each beacon.

Frequently, only a single message is transmitted during the interval between two beacons to one participant and only very rarely several messages. However, the additional counter has to be inserted into each message for the encryption to function correctly, which results, in most cases, to unnecessary overhead due to only a single message.

Alternatively, the counter can only be transmitted to a participant after the second message during the interval between two beacons. The participant knows that the first message is transmitted without the additional counter and the subsequent messages comprise the counter.

In embodiments, the further counter can only be transmitted after the second message to a participant during the interval between two beacons.

In order to completely prevent transmission of an additional counter, the same can also be derived implicitly from the transmission time within the range between two beacons. Thus, the receiver knows that, for example, when receiving a transmission at the first possible position within a beacon period, the additional counter has the value 0, at the second possible position the value 1, etc. In section A, each resource element is provided with a resource element counter running from 0 to N_RE_beaconPeriod (i.e., the number of resource elements within a beacon period) and starts again at zero in the next beacon period. Thus, this resource element counter is perfectly suited as transmitting position.

In embodiments, the further counter can be implicitly derived from the transmission position within the beacon period and therefore does not have to be transmitted.

C.6 Order of the Sub-Packets is Derived from the Grid

New messages can arrive at the base station at any time, that are then to be transmitted promptly. For the mode with (ultra-) low latency it is essential that the transmission starts possibly in the next possible resource element or time slot. This causes several problems at the receiver, depending on the used pilot sequences:
When the pilot sequence is unique for each sub-data packet, the receiver has to be able to detect all possible pilot sequences. These parallel detectors result in a heavily increased computing load and increase the error detection probability as a whole, as the error detections of the individual detectors accumulate.
When the pilot sequences within a telegram are the same, the allocation of the received sub-data packet to a sub packet index in case of a packet loss at the start or end of a telegram is ambiguous. In both cases, the receiver receives a contiguous number of sub-data packets that is below the number of sub-data packets to be expected as a whole, without any absolute reference.
When this pilot sequence is additionally identical for all telegrams, this problem increases. For wireless transmission of several telegrams in the same slot, the receiver does not know which sub-data packets are part of a transmission.

Therefore, all possible combinations have to be tested, which increases the computing load.

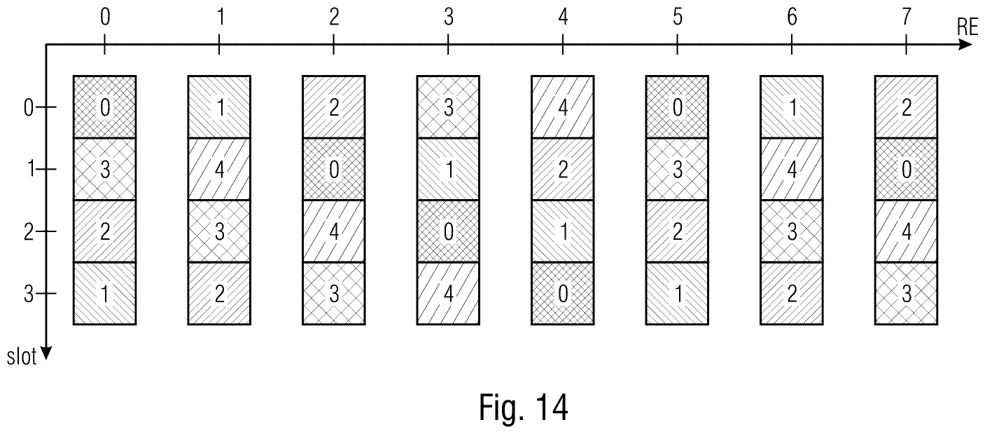

In embodiments, these problems can be reduced by a sub-data packet allocation derived from the grid. This allocation takes place individually for the four HDR time slots exemplarily illustrated in FIG. 11 for one resource element. FIG. 14 shows a possible allocation of the sub-data packets according to their indices based on the resource element index and the time slot index (slot). In this allocation, in the time slot 0, sub-data packets with the index RE % 5 are transmitted, in the time slot 1 sub-data packets with the index (RE+3) % 5 (wherein % corresponds to the modulo operator), in the time slot 2 sub-data packets with the index (RE+2) % 5 and in the time slot 3 sub-data packets with the index (RE+1) % 5. By this time slot-dependent allocation, the repetition of the sub-data packets of section C.2 is enabled. Thereby, the sub-data packets are not received in a strictly increasing order.

In detail, FIG. 14 shows in a diagram a schematic view of an allocation of the sub-data packets according to their indices based on the selected time slot for the first eight resource elements of the second channel access pattern. Here, in FIG. 14, the ordinate describes the time slot indices and the abscissa the resource element indices.

By the structure shown in FIG. 14 with four transmission time slots per resource element, it is possible, for example, to transmit the initial transmission in time slot 0 or time slot 1 and the repetition in each (e.g., subsequent) free time slot in the same resource element, e.g., because identical sub-data packets are never transmitted there.

For a possible advantageous arrangement for the repeated transmissions, for example, the following table applies:

| | | | |
|---|---|---|---|
| Time slot index for initial emission | 0 | 0 | 1 |
| Time slot index for repeated emission | 2 | 1 | 3 |

For example: It is assumed that an emission at the time of the resource element starts with index 1, uses no repetition, uses the time slot with index 0 and includes 5 sub-data packets. Thus, according to FIG. 14, first, the sub-data packet with the index 1, then the sub-data packet with index 2, then the sub-data packet with index 3, then the sub-data packet with index 4 and finally the sub-data packet with index 0 is emitted.

If a (further) emission to the resource element starts with the index 0 and uses the time slot with the index 1 (e.g., since in the time slot with index 0 another transmission takes place already), the sub-data packets will be emitted in the following order: (3, 4, 0, 1, 2). If in the first two resource elements additionally repetitions in the time slot are transmitted with the index 3 according to section C.2, this would be the sub-data packets with the indices 2 and 3.

With this allocation, it is clear for the receiver which of the five sub-data packets has each been received, which allows a simple reconstruction of the original symbol order (deinterleaving):
When an individual pilot sequence is used for each sub-data packet, the same is known in advance due to the respective sub-data packet index due to this fixed allocation. Thereby, only one detection per time slot has to be calculated, which is favorable for the computing power and error detection probability.
When a common pilot sequence is used within a telegram, a non-received sub-data packet at the start or end of the telegram only has a limited effect. These packet losses have no influence on the sub-data packet allocation and hence the reconstructed symbol order.
When only a single pilot sequence is used for all sub-data packets of all telegrams, the start and end of the individual telegrams can also not be clearly determined. When a decoding attempt for subsequent sub-data packets is started, their packet allocation is clear, which reduces the number of options to be tested.

In embodiments, the counter of the time slots (RE or resource element indices) and the position within the time slots can determine, which sub-data packet is transmitted.

### D. Further Embodiments

Embodiments are applied in systems for radio transmission of data from terminal devices to a base station or from one/several base stations to terminal devices. Here, a system can be, for example, a personal area network (PAN) or a low-power wide area network (LPWAN), wherein the terminal devices can be, for example, battery-operated sensors (sensor nodes).

Embodiments aim at cases of application in which a message (data packet) is transmitted in a radio network in several partial data packets (so-called telegram splitting method [x]) and in which several uncoordinated radio networks access shared radio resources (e.g., shared frequency band).

As has already been mentioned, the embodiments described herein can be used to transmit data between the participants of the communication system based on the telegram splitting method. In the telegram splitting method, data like a telegram or data packet, are divided into a plurality of sub-data packets (or partial data packets or partial packets) and the sub-data packets are transferred from one participant to another participant (like from the base station to the terminal point or from the terminal point to the base station) of the communication system distributed in time and/or frequency using a time and/or frequency hopping pattern, wherein the participant which receives the sub-data packets assembles (or combines) same again to obtain the data packet. Each of the sub-data packets contains only a part of the data packet. Additionally, the data packet can be channel-encoded so that not all the sub-data packets, but only a part of the sub-data packets is needed for error-free decoding of the data packet.

When transmitting data based on the telegram splitting method, the sub-data packets can be transmitted distributed in a subset (e.g., a selection) of the available resources of the network-specific channel access pattern. In detail, the sub-data packets can be transmitted based on the relative channel access pattern, that is in the resources of the relative channel access pattern. Exemplarily, one sub-data packet can be transmitted per resource.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded. The data carrier, the digital storage medium, or the recorded medium are typically tangible, or non-volatile.

A further embodiment of the inventive method thus is a data stream or a sequence of signals representing the computer program for performing any of the methods described herein. The data stream or the sequence of signals may be configured, for example, to be transmitted via a data communication link, for example via the internet.

A further embodiment includes a processing unit, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

For example, the apparatuses described herein may be implemented using a hardware device, or using a computer, or using a combination of a hardware device and a computer.

The apparatuses described herein, or any components of the apparatuses described herein, may at least be partially implement in hardware and/or software (computer program).

For example, the methods described herein may be implemented using a hardware device, or using a computer, or using a combination of a hardware device and a computer.

The methods described herein, or any components of the methods described herein, may at least be partially implement by performed and/or software (computer program).

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LIST OF REFERENCES

[1] ETSI TS 103 357 V1.1.1 (2018 June)—“Short Range Devices; Low Throughput Networks (LTN); Protocols for radio interface A.”
[2] DE 10 2018 210 245 A1
[3] DE 10 2017 204 181 A1
[4] DE 10 2011 082 098 B4

### List of Abbreviations

CRC: Cyclic Redundancy Check
LPWAN: Low Power Wide Area Network
LSB: Least Significant Bit(s)
MSB: Most Significant Bit(s)
PAN: Personal Area Network
TLS: Transport Layer Security
TSMA: Telegram-Splitting-Multiple-Access

1. Terminal point of a wireless communication system,
wherein the terminal point is configured to operate in a first mode and in a second mode,
wherein the terminal point is configured to receive a signal, wherein the signal comprises information on a first channel access pattern for the first mode,
wherein the terminal point is configured to determine the first channel access pattern for the first mode based on the information on the first channel access pattern,
wherein the terminal point is configured to determine a second channel access pattern for the second mode based on the information on the first channel access pattern,
wherein the terminal point is configured to transmit and/or receive data in the second mode by using the second channel access pattern,
wherein the first channel access pattern for the first mode allows data transmission with a first latency,
wherein the second channel access pattern for the second mode allows data transmission with a second latency,
wherein the second latency is lower than the first latency.

2. Terminal point according to claim 1,
wherein the terminal point is configured to determine the second channel access pattern exclusively based on the information on the first channel access pattern.

3. Terminal point according to claim 1,
wherein the terminal point is configured to determine the first channel access pattern from the information of the signal via a first mapping rule,
wherein the terminal point is configured to determine the second channel access pattern from the information of the signal via a second mapping rule.

4. Terminal point according to claim 1,
wherein the information on the first channel access pattern describes a state of a numerical sequence generator for generating a numerical sequence or wherein the information on the first channel access pattern describes a number of a numerical sequence, wherein the numerical sequence determines the first channel access pattern.

5. Terminal point according to claim 1,
wherein the first channel access pattern indicates a frequency and/or time hopping-based occupancy of resource elements usable for the communication of the communication system,
and/or wherein the second channel access pattern indicates a frequency and/or time hopping-based occupancy of resource elements usable for the communication of the communication system.

6. Terminal point according to claim 5,
wherein one resource element each of the second channel access pattern is temporarily within a respective time interval between the two immediately successive resource elements of the first channel access pattern.

7. Terminal point according to claim 5,
wherein a reference point of a respective resource element of the second channel access pattern comprises a fixed time interval to a reference point of a respective resource element of the first channel access pattern.

8. Terminal point according to claim 5,
wherein the terminal point is configured to receive data divided onto a plurality of sub-data packets according to the second channel access pattern,
wherein the plurality of sub-data packets are transmitted in a plurality of successive resource elements of the second channel access pattern,
wherein an order in which the plurality of sub-data packets are transmitted depends on indices of the resource elements of the second channel access pattern in which the plurality of sub-data packets are transmitted,
or wherein an order in which the plurality of sub-data packets are transmitted depends on indices of the resource elements of the first channel access pattern that immediately precede the respective resource elements of the second channel access pattern in which the plurality of sub-data packets are transmitted.

9. Terminal point according to claim 5,
wherein the data comprise a data packet that is transmitted divided onto five sub-data packets,
wherein the plurality of sub-data packets are transmitted in five successive resource elements of the second channel access pattern,
wherein an order in which the five sub-data packets are transmitted depends on
an index of a resource element of the second channel access pattern or the first channel access pattern that immediately precedes a respective resource element of the second channel access pattern in which a transmission of the five sub-data packets starts, and
an index of a slot within the respective resource elements in which the five sub-data packets are transmitted,
wherein the order in which the five sub-data packets are transmitted is based on the following table:

| | | Resource Element Index | | | | | | | |
|---|---|---|---|---|---|---|---|---|---|
| | | 0 | 1 | 2 | 3 | 4 | 5 | 6 | 7 |
| Slot | 0 | 0 | 1 | 2 | 3 | 4 | 0 | 1 | 2 |
| Index | 1 | 3 | 4 | 0 | 1 | 2 | 3 | 4 | 0 |
| | 2 | 2 | 3 | 4 | 0 | 1 | 2 | 3 | 4 |
| | 3 | 1 | 2 | 3 | 4 | 0 | 1 | 2 | 3 |

wherein each element in the table describes an index of a respective sub-data packet.

10. Base station of a wireless communication system,
wherein the base station is configured to operate in a first mode and in a second mode,
wherein the base station is configured to transmit a signal, wherein the signal comprises information on a first channel access pattern for the first mode,
wherein the base station is configured to determine the first channel access pattern for the first mode based on the information on the first channel access pattern,
wherein the base station is configured to determine a second channel access pattern for the second mode based on the information on the first channel access pattern,
wherein the base station is configured to transmit and/or receive data in the second mode by using the second channel access pattern,
wherein the first channel access pattern for the first mode allows data transmission with a first latency,
wherein the second channel access pattern for the second mode allows data transmission with a second latency,
wherein the second latency is lower than the first latency.

11. Base station according to claim 10,
wherein the base station is configured to determine the second channel access pattern exclusively based on the information on the first channel access pattern.

12. Base station according to claim 10,
wherein the base station is configured to determine the first channel access pattern from the information of the signal via a first mapping rule,
wherein the base station is configured to determine the second channel access pattern from the information of the signal via a second mapping rule.

13. Base station according to claim 10,
wherein the information on the first channel access pattern describes a state of a numerical sequence generator for generating a numerical sequence or wherein the information on the first channel access pattern describes a number of a numerical sequence, wherein the numerical sequence determines the first channel access pattern.

14. Base station according to claim 10,
wherein the first channel access pattern indicates a frequency and/or time hopping-based occupancy of resource elements usable for the communication of the communication system,
and/or wherein the second channel access pattern indicates a frequency and/or time hopping-based occupancy of resource elements usable for the communication of the communication system.

15. Base station according to claim 14,
wherein one resource element each of the second channel access pattern is temporarily within a respective time interval between the two immediately successive resource elements of the first channel access pattern.

16. Base station according to claim 14,
wherein a reference point of a respective resource element of the second channel access pattern comprises a fixed time interval to a reference point of a respective resource element of the first channel access pattern.

17. Base station according to claim 14,
wherein the base station is configured to transmit data divided onto a plurality of sub-data packets according to the second channel access pattern,
wherein the plurality of sub-data packets are transmitted in a plurality of successive resource elements of the second channel access pattern,
wherein an order in which the plurality of sub-data packets are transmitted depends on indices of the resource elements of the second channel access pattern in which the plurality of sub-data packets are transmitted,
or wherein an order in which the plurality of sub-data packets are transmitted depends on indices of the resource elements of the first channel access pattern that immediately precede the respective resource elements of the second channel access pattern in which the plurality of sub-data packets are transmitted.

18. Base station according to claim 14,
wherein the data comprise a data packet that is transmitted divided onto five sub-data packets,
wherein the plurality of sub-data packets are transmitted in five successive resource elements of the second channel access pattern,
wherein an order in which the five sub-data packets are transmitted depends on
an index of a resource element of the second channel access pattern or the first channel access pattern that immediately precedes a respective resource element of the second channel access pattern in which a transmission of the five sub-data packets starts, and
an index of a slot within the respective resource elements in which the five sub-data packets are transmitted,
wherein the order in which the five sub-data packets are transmitted is based on the following table:

| | | Resource Element Index | | | | | | | |
|---|---|---|---|---|---|---|---|---|---|
| | | 0 | 1 | 2 | 3 | 4 | 5 | 6 | 7 |
| Slot | 0 | 0 | 1 | 2 | 3 | 4 | 0 | 1 | 2 |
| Index | 1 | 3 | 4 | 0 | 1 | 2 | 3 | 4 | 0 |
| | 2 | 2 | 3 | 4 | 0 | 1 | 2 | 3 | 4 |
| | 3 | 1 | 2 | 3 | 4 | 0 | 1 | 2 | 3 |

wherein each element in the table describes an index of a respective sub-data packet.

19. Method for operating a terminal point of a communication system, wherein the terminal point is configured to operate in a first mode and in a second mode, the method comprising:
receiving a signal, wherein the signal comprises information on a first channel access pattern for the first mode,
determining the first channel access pattern for the first mode based on the information on the first channel access pattern,
determining the second channel access pattern for the second mode based on the information on the first channel access pattern,
transmitting and/or receiving data by using the second channel access pattern,
wherein the first channel access pattern for the first mode allows data transmission with a first latency,
wherein the second channel access pattern for the second mode allows data transmission with a second latency,
wherein the second latency is lower than the first latency.

20. Method for operating a base station of a communication system, wherein the base station is configured to operate in a first mode and in a second mode, the method comprising:
transmitting a signal, wherein the signal comprises information on a first channel access pattern for the first mode,
determining the first channel access pattern for the first mode based on the information on the first channel access pattern,
determining the second channel access pattern for the second mode based on the information on the first channel access pattern,
transmitting and/or receiving data by using the second channel access pattern,
wherein the first channel access pattern for the first mode allows data transmission with a first latency,
wherein the second channel access pattern for the second mode allows data transmission with a second latency,
wherein the second latency is lower than the first latency.
